(19) United States
(12) Patent Application Publication
(10) Pub. No.: US 2005/0238889 A1
(43) Pub. Date: Oct. 27, 2005

(54) Layered components, materials, methods of production and uses thereof

(76) Inventors: Nancy Iwamoto, Ramona, CA (US); Joseph Kennedy, San Jose, CA (US); Eal Lee, Milpitas, CA (US)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/875,050

(22) Filed: Jun. 22, 2004

Related U.S. Application Data
(60) Provisional application No. 60/486,878, filed on Jul. 10, 2003.

(51) Int. Cl. B32B 9/04

(52) U.S. Cl. 428/446; 428/304.4; 428/65.1; 428/447; 427/248.1

(57) ABSTRACT

A layered component is described herein that includes: a substrate; a dielectric material having a plurality of pores, wherein the material is coupled to the substrate; and a self-assembled diffusion blocking material coupled to the dielectric material, wherein the diffusion blocking material is attracted to the dielectric material. A layered component is also described herein that includes: a substrate; a dielectric material having a plurality of pores, wherein the material is coupled to the substrate; and a self-assembled diffusion blocking material coupled to the dielectric material, wherein the diffusion blocking material reacts with the dielectric material. A layered material is described that includes: a) a porous material comprising a porous surface; and b) a layer of blocking material comprising reactive functionalities coupled to the porous surface, wherein the interaction of the reactive functionalities with the porous material forms a diffusion blocking layer. Methods are also described of minimizing the diffusion of metal atoms, reactive etchants or CVD/ALD precursor materials into a material having a plurality of pores are disclosed herein that include: a) providing a precursor material that comprises a carbon-including material; b) providing a solvent carrier solution; c) combining the precursor material and the solvent carrier solution to form a diffusion blocking reactive solution; and d) applying the diffusion blocking reactive solution to the material having a plurality of pores to form a diffusion blocking material.

This application is related to PCT Application Serial No.: PCT/US03/17656 filed on Jun. 3, 2003, which claims priority to U.S. Provisional Patent Application Ser. No. 60/385,482 filed on Jun. 3, 2002, which are commonly-owned and incorporated herein in their entireties. This application also claims priority to U.S. Provisional Patent Application Ser. No. 60/486,878 filed on Jul. 10, 2003, which is commonly-owned and incorporated herein in its entirety.

### FIELD OF THE SUBJECT MATTER

The field of the subject matter described herein is layered components for electronic and semiconductor applications, the materials and methods of production thereof, including controlling and minimizing diffusion of conductive or performance-degrading atoms and/or molecules into underlying and adjacent layers of materials.

### BACKGROUND OF THE SUBJECT MATTER

In the past 20 years, integrated circuit feature sizes have dropped about 100 fold from 10,000 nm to about 100 nm. Integrated circuit technology's push for greater density/smaller size, greater cost efficiency and higher performance has generally ignored the effect of feature size on material transport. When feature sizes approach and drop down below about 100 nm, atomic scale issues begin to influence performance. For example, recently developed copper conductors, which are utilized in high performance devices, are exhibiting a resistivity dependence on feature size. Table 1 shows how feature size and process complexity are expected to evolve into the next 20 years and how material selection is and will continue to be an important consideration in the performance of layered materials and components.

| 2003 ITRS Near Term | 2003 | 2004 | 2005 | 2006 | 2007 | 2008 | 2009 |
|---|---|---|---|---|---|---|---|
| DRAM ½ pitch (nm) | 100 | 90 | 80 | 70 | 65 | 57 | 50 |
| MPU/ASIC ½ pitch | 120 | 107 | 95 | 85 | 76 | 67 | 60 |
| MPU Printed Gated Length | 65 | 53 | 45 | 40 | 35 | 32 | 28 |
| MPU Physical Gate Length | 45 | 37 | 32 | 28 | 25 | 22 | 20 |
| # Metal Layers | 9 | 10 | 11 | 11 | 11 | 12 | 12 |
| Metal 1 wiring pitch (nm) | 240 | 214 | 190 | 170 | 152 | 134 | 120 |
| Interlevel metal Insulator bulk dielectric | <3.0 | <2.7 | <2.7 | <2.7 | <2.4 | <2.4 | <2.4 |
| constant (minimum expected) | | | | | | | |
| Barrier/Cladding Thickness (nm) | 12 | 10 | 9 | 8 | 7 | 6 | 6 |

| 2003 ITRS Long Term | 2010 | 2012 | 2013 | 2015 | 2016 | 2018 |
|---|---|---|---|---|---|---|
| DRAM ½ pitch (nm) | 45 | 35 | 32 | 25 | 22 | 18 |
| MPU/ASIC ½ pitch | 54 | 42 | 38 | 30 | 27 | 21 |
| MPU Printed Gated Length | 25 | 20 | 18 | 14 | 13 | 10 |
| MPU Physical Gate Length | 18 | 14 | 13 | 10 | 9 | 7 |
| # Metal Layers | 12 | 12 | 12 | 13 | 14 | 14 |
| Metal 1 wiring pitch (nm) | 108 | 84 | 76 | 60 | 54 | 42 |
| Interlevel metal Insulator bulk dielectric | <2.1 | <2.1 | <1.9 | <1.9 | <1.7 | <1.7 |
| constant (minimum expected) | | | | | | |
| Barrier/Cladding Thickness (nm) | 5 | 4 | 3.5 | 3 | 2.5 | 2 |

Another example of this performance initiative has been to develop dielectric constant materials having a dielectric constant (k) less than about 3 to meet all of the properties required for current and future dual damascene integration. In order to decrease the dielectric constant of these materials below about 3 (which are materials considered as “low k dielectric materials” or “low dielectric constant materials”), controlled porosity must be introduced into the dielectric material. Porosity is required because the available synthesized high temperature materials have hit the fundamental material limits of their dielectric properties. Atomic scale pores (about 2 nm in size) must have tight size control that is retained at elevated temperatures. Gaseous and atomic transport in these porous systems must be investigated and improved, since these materials experience a wide range of temperature and gaseous processing during interconnect integration. In addition, pore sizes in low k dielectrics will need to be on the order of 5% of the minimum interconnect feature size to provide minimal via/trench sidewall roughness for subsequent barrier/seed depositions. Another consideration is that even without extrinsically generated porosity, free volume exists in any material matrix that is available for transport of materials. This “open space” is present in all materials—whether pores are intentionally added/generated in the material.

Prior Art FIG. 1 shows a simulation of how the atomic arrangement of amorphous SiO₂—a commonly used semiconductor intermetal dielectric—may look after formation by a thermal or CVD growth process. Prior Art FIG. 2 shows a log-normal model of the interstitial pore size distribution of amorphous silica, as compared to several gases. (G. S. Nakayama and J. F. Shackelford, J. Non-Crystalline Solids (126), 249-254 (1990)). Although practitioners in the semiconductor industry have routinely used this and similar materials for decades, it is relatively unappreciated that some gases can readily move through the matrix of this material, especially for thin films at elevated temperatures. Barrer examined the diffusion of gases through fused silica, and showed that transport can be substantial even at room temperature. (R. M. Barrer, Diffusion In and Through Solids, Cambridge University Press, 1941). These results are collected and considered before one begins to consider materials with porosity. Prior Art FIG. 3 shows the computationally generated spatial arrangement of atoms in a polymethylmethacrylate (PMMA) polymer, providing a perspective of the free space that can be present in polymeric materials. The free space within a material can be accessible to diffusion depending upon variables such as temperature, lattice energy, chain rigidity, and other bond forces that would determine rearrangement of the atomic structure.

In addition to the conditions and processes mentioned above, chemical vapor deposition (hereinafter referred to as “CVD”) processes can be especially detrimental to materials and layered materials, since CVD processes are performed in a gaseous state at high temperatures—encouraging penetration and migration of conductive atoms and molecules into nearby and/or adjacent materials.

Diffusion of species into adjacent layers, such as dielectric layers, will influence many performance characteristics and attributes, including a) dielectric constant, b) etch behavior, c) chemical mechanical processing (CMP) survivability, d) clean behavior and e) electrical reliability. Therefore, the analysis of the likelihood of diffusibility and the determination of the materials and conditions that can reliably control the likelihood of diffusibility would be a beneficial analysis to undertake. To this end, one of the methods used to determine if a material has a likelihood of diffusibility—the effective viscosity of the material and the pore diameter should be investigated, calculated, documented and combined with one another to determine the diffusion constant—which is an indicator of the diffusibility of a material into an underlying material. Related concepts are described in “Transport Considerations in Porous Low K and Metal Interconnect Systems Approaching Atomic Dimensions” by Michael E. Thomas, Douglas M. Smith, Stephen Wallace and Nancy Iwamoto (IITC Jun. 3-5, 2001, San Francisco, Calif.). Once the analysis is complete, recognition and assembly of the proper/suitable layered materials, single-layer materials and components would be ideal to increasing the performance of integrated circuits and related components, while increasing the cost efficiency during design and production of the material and/or component. In addition, once the effective viscosity of the material and the pore diameter of the material are determined, the material should be evaluated to determine if an additional layer of material, reactive component or integrated component should be or could be added or coupled between the material in question and the potentially high diffusible layer or material.

### SUMMARY OF THE SUBJECT MATTER

A layered component is described herein that includes: a substrate; a dielectric material having a plurality of pores, wherein the material is coupled to the substrate; and a self-assembled diffusion blocking material coupled to the dielectric material, wherein the diffusion blocking material is attracted to the dielectric material.

A layered component is also described herein that includes: a substrate; a dielectric material having a plurality of pores, wherein the material is coupled to the substrate; and a self-assembled diffusion blocking material coupled to the dielectric material, wherein the diffusion blocking material reacts with the dielectric material.

A layered material is described that includes: a) a porous material comprising a porous surface; and b) a layer of blocking material comprising reactive functionalities coupled to the porous surface, wherein the interaction of the reactive functionalities with the porous material forms a diffusion blocking layer.

Methods are also described of minimizing the diffusion of metal atoms, reactive etchants or CVD/ALD precursor materials into a material having a plurality of pores are disclosed herein that include: a) providing a precursor material that comprises a carbon-including material; b) providing a solvent carrier solution; c) combining the precursor material and the solvent carrier solution to form a diffusion blocking reactive solution; and d) applying the diffusion blocking reactive solution to the material having a plurality of pores to form a diffusion blocking material.

### BRIEF DESCRIPTION OF THE FIGURES

Table 1 shows how evolving feature size and process complexity will impact materials selection.

Prior Art FIG. 1 shows a molecular simulation of how the atomic arrangement of amorphous SiO₂ may look after formation by a thermal or CVD growth process.

Prior Art FIG. 2 shows a log-normal model of the interstitial pore size distribution of amorphous silica.

Prior Art FIG. 3 shows the computationally generated special arrangement of atoms in a polymethylmethacrylate (PMMA) polymer.

FIG. 4 shows a simulation of the Pore Size versus Rate of Copper Migration for a contemplated layered material.

FIG. 5 shows the Dielectric Layer Density versus the Rate of Copper Migration for a contemplated layered material.

FIG. 6 shows the Interfacial C Density versus the Rate of Copper Migration for a contemplated layered material.

FIG. 7 shows a “master curve” that gives the range of material diffusion coefficient values for transport of a gas, liquid or solid species through a material of varying thickness, x.

FIG. 7A shows the “master curve” from FIG. 7 with the small gas molecule transport regime highlighted.

FIG. 8 shows the relationship between diffusant size and pore size.

FIG. 9 shows an example of viscosity range estimates using a minimum lagtime of 60 seconds.

FIG. 10 shows a graph of the log (particle diameter in m) versus log (particles/m³).

FIG. 11 shows a graph of the log (particle radius in cm) versus log (diffusion coefficient).

FIG. 12 shows two graphs of the log (particle radius in cm) versus log (diffusion coefficient).

FIG. 13 shows a plot of the diffusion coefficient of several standard gases.

FIG. 14 shows a plurality of ordered silicon atoms.

FIG. 15 shows the plurality of silicon atoms once diffusion of the copper atom has begun.

FIG. 16 shows the diffusion of a copper atom from a side view.

FIG. 17 shows the diffusion of a copper atom from a top down view.

FIG. 18 shows an experimental simulation of a porous organic matrix.

FIG. 19 shows copper diffusion activation energies.

FIG. 20 shows a molecular simulation of a porous material.

FIG. 21A shows several contemplated silica-based blocking agents where the rigid core and surface branched structure are organosilane-based.

FIG. 21B shows several contemplated organic blocking agents where the rigid core and surface branched structure are all organic based.

FIG. 22 shows several contemplated mixed organic/inorganic blocking agents where the rigid core and surface branched structure are a mixed silane and organic

FIG. 23 shows the blocker/pore area ratio versus relative activation energy.

FIG. 24A shows dielectric blocker interaction energy (kcal/mol) verses activation energy (kcal/mol).

FIG. 24B shows blocker/pore opening ratio versus dielectric-blocker interaction energy (kcal/mol).

FIG. 25A shows the blocker cross section/pore opening versus the activation energy.

FIG. 25B shows the blocker/pore area ratio versus relative activation energy.

FIG. 26 shows the activation energy summaries from contemplated experimental simulations.

FIG. 27 shows two graphs (A) and (B) that indicate the differences between a rigid pore (fixed) and a flexible pore (moving or “unfixed”).

FIG. 28 shows that when a GX3™ pore is used with silica blockers only, the worst case is predicted by assuming a rigid pore.

FIG. 29 shows that for silicon-based pores, the matrix effect difference is less pronounced

FIG. 30 shows several contemplated embodiments using dendrimer T8 silsesquioxane cores.

FIG. 31 shows several contemplated embodiments using dendrimer T8 silsesquioxane cores.

FIG. 32 shows several contemplated embodiments using dendrimer T8 silsesquioxane cores.

FIG. 33 shows several contemplated embodiments using GX3™ pores.

FIG. 34 shows several contemplated embodiments using silica pores.

### DETAILED DESCRIPTION

Layered components, single layer components and materials are described herein that comprise at least one layer or at least one material that can effectively reduce the diffusion of migratory atoms, molecules and/or diffusants, such as conductive molecules, conductive atoms, metal atoms, metal-including molecules, reactive etchants and/or ALD or CVD precursor materials into the underlying material (such as a porous dielectric layer). Essentially, as previously described, all materials comprise a plurality of pores or voids that allow for the diffusion and subsequent contamination of metal atoms, conductive materials or other undesirable materials and atoms, such as those previously described, into the underlying/porous layer. (see “Copper Contamination Induced Degradation of MOSFET Characteristics and Reliability” by M. Inohara, H. Sakurai, T. Yamaguchi, H. Tomita, T. Iijima, H. Oyamatus, T. Nakayama, H. Yoshimura and Y. Toyoshima, 2000 Symposium on VLSI Technology Digest of Technical Papers).

As mentioned earlier, once a material is selected to be used as a material or component or to be incorporated into a layered material, the likelihood of diffusibility should be calculated. In order to adequately determine the likelihood of diffusibility, migration and critical concentration of the diffusing atoms and/or molecules should be reviewed and investigated. The issue of migration and critical concentration can be investigated from several different perspectives, including modeling and simulation or application of diffusion theory.

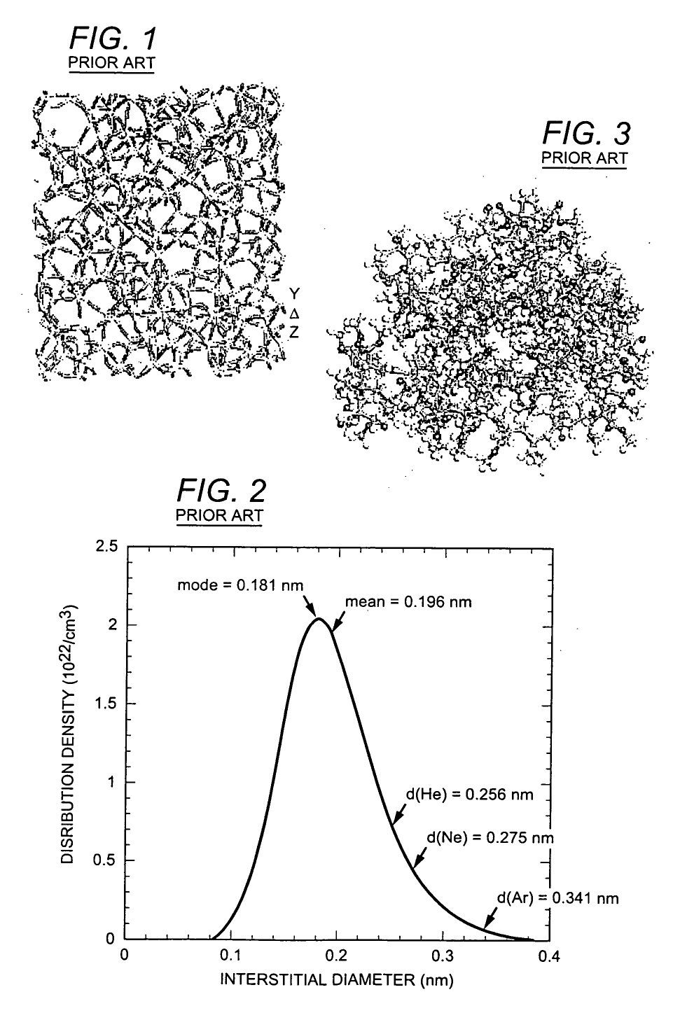

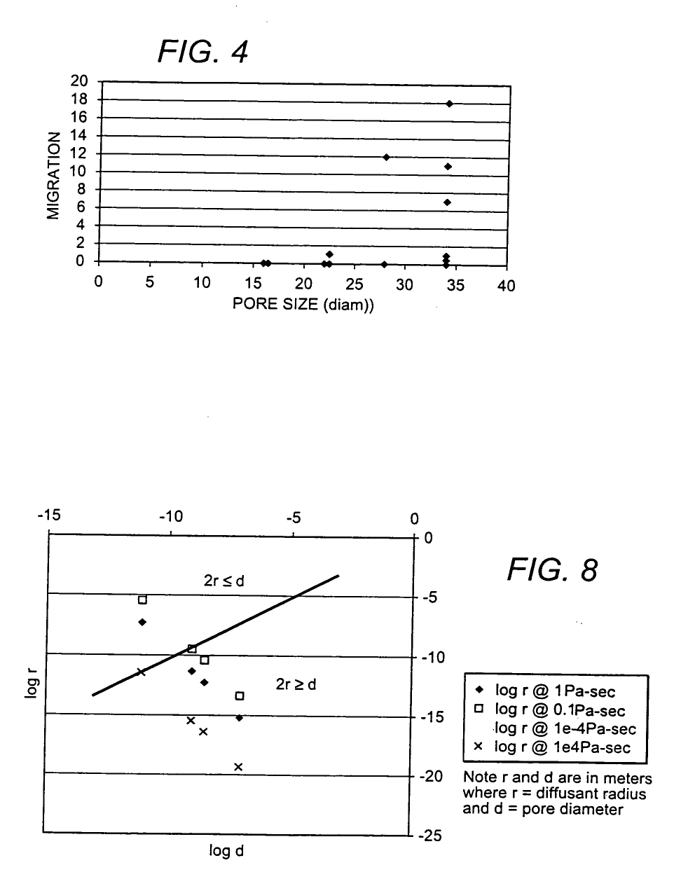

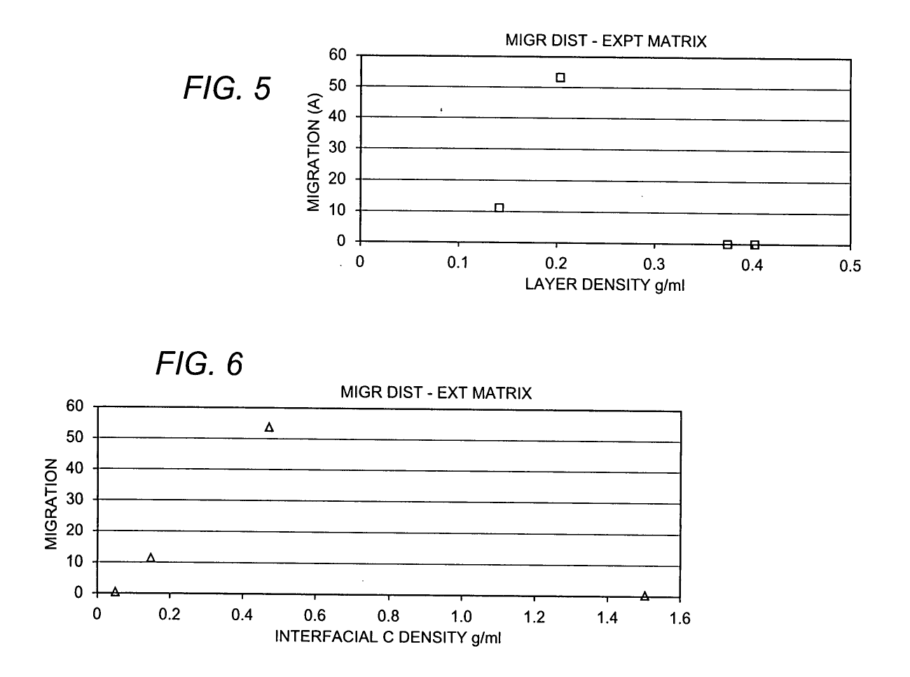

One way to gain a perspective on the likelihood of diffusibility is to simulate a typical migration scenario, such as a layered material that comprises copper coupled to an organic dielectric. When molecular modeling is utilized to examine migration stability of a copper layer in contact next to an organic dielectric, where the layered material is allowed to equilibrate at the target temperature of 700K, it is found that copper migration can be blocked depending upon pore size of the dielectric material, density of the interfacial layer formed by the dielectric material or the density of the dielectric. FIG. 4 shows a simulation of the pore size versus rate of copper migration for a contemplated layered material. As shown, the pore size should be less than 25 Angstroms to reduce or stop migration, according to the simulation. FIG. 5 shows the dielectric layer density versus the rate of copper migration for a contemplated layered material. As shown, the dielectric layer density should be around 0.3 to 0.4 g/ml to reduce or stop migration (this includes the interfacial region described in FIG. 6). FIG. 6 shows the density of the dielectric material immediately next (the top 2-5 A of dielectric surface) to the copper layer (Interfacial C Density) versus the rate of copper migration for a contemplated layered material. As shown, the Interfacial C density should be around 1.5 g/ml to reduce or stop migration. As suggested, the immediate surface next to the copper interface is one important aspect of reducing or stopping migration tendencies before the diffusing species has entered into the dielectric volume. Similar results have been found for inorganic dielectric materials. Modeling experiments have further shown that by changing the choice of interfacial substituents, the interfacial density can be increased to prevent migration on both inorganic and organic materials. The interfacial density could be changed by choice of pendant groups attached to the basic dielectric structure or by reactive components from either formulation or from process after dielectric formation such as CVD, ALD, plasma etch, or liquid and solvent process such as wet etch, clean, CMP (chemical mechanical polishing), which have a solvent involved and can potentially carry reactive groups to the dielectric.

Another method to gain perspective on the likelihood of diffusibility is by using diffusion theory, as alluded to earlier. Diffusion theory involves investigating the rate of gas transport through a material—which is the material's permeability. Specifically, the term “permeability” is defined as the measure of material flux through a unit cross section of material of thickness, x, under a pressure differential. Permeability is related to the diffusion coefficient in Equation (1) by the solubility of the diffusing species in the material:
P=D×S (1)
where:
P=Permeability of the material (atoms-cm/cm²-sec-torr)
D=Diffusion Coefficient (cm²/sec)
S=Solubility (atoms/cm³ of solid-torr)
   Typical activation energies associated with the diffusion coefficient D and gas solubility S can be obtained for a membrane through which gas diffusion has reached steady state, using the following expression (Equation (2)):
   t_{Lag}=x²/6D (2)
   where:
x=thickness of the membrane (cm)
t_{Lag}=Diffusion time (sec) required to establish steady state diffusion
D=Diffusion coefficient (cm²/sec)
   D can be calculated from the time required to attain steady state permeation using Equation (2). (W. Jost, Diffusion, Third Edition, Academic Press, 1960. and H. Daynes, Proc. Royal Society, A (97) 286 (1920)). The permeability, P, measured at steady state along with D, give the solubility of the gas, S, in the material. Equation (2) is highly informative, since it indicates what the diffusion coefficient has to be regardless of the material, for transport of gases or other materials through a dielectric or metal film of thickness, x.

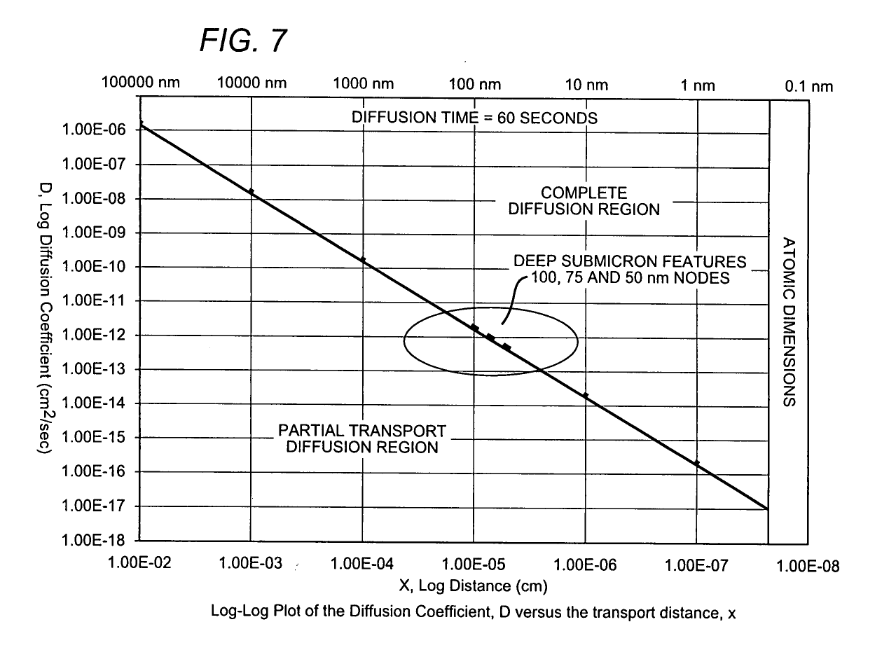

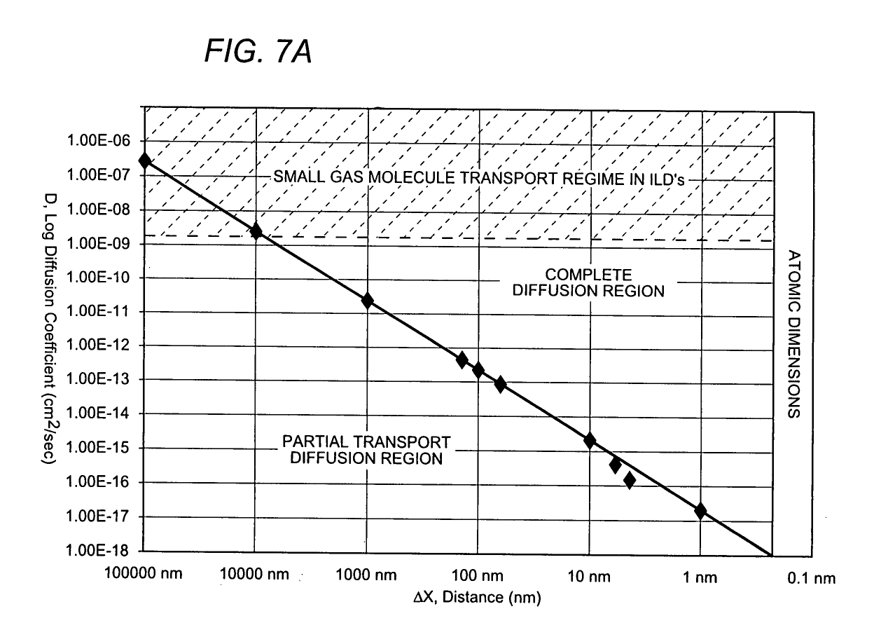

FIG. 7 shows a “master curve” that gives the range of material diffusion coefficient values for transport of a gas, liquid or solid species through a material of varying thickness, x, for a time of 60 seconds based on Equation (2). These conditions are typical of single wafer process times. FIG. 7A shows the same “master curve” that is shown in FIG. 7, however, the small gas molecule transport regime for interlayer dielectrics (ILDs) is highlighted. Based on the information in FIGS. 7 and 7A, it is clear that interconnect materials will need to possess very small diffusion coefficients to resist appreciable gaseous, liquid or solid penetration in the material during processing. It is also evident that a material should have a diffusion coefficient less than about 10⁻¹² cm²/sec to avoid complete diffusional transport of a foreign species through it, if the lateral or vertical dimension of the material is only 100 nm thick.

If we have an estimation of the activation energy for diffusion (or the lattice movement activation energy, Eₐ) we can make an estimate of the diffusion coefficient:
D=(kT/h)d²exp[−Eₐ/RT]
where D is the diffusion coefficient, d is the lattice spacing or pore dimension in a low k dielectric. By rearranging this equation to look at the pore dimensions,
d²=Dh/[kTexp(−E/RT)]
and then comparing it to a combination of Fick's first law and Stokes law to look at the diffusant dimensions:
r=kT/[6(pi)nD]
(where r is the diffusant radius, n is the viscosity and D is the diffusion coefficient.), we can use these relationships to look at the effects of the dielectric matrix through the viscosity. This analysis gives a maximum D of ˜1×10⁻⁹ m²/sec using a minimum pore size of 20 Å.

Using these same equations that show the quantitative relationship between the pore diameter and the diffusant radius, the required “effective” viscosity can also be estimated at greater than 100 Pa-sec, for the range of diffusant diameter and pore diameter between 1-100 Å, and which also assumes that the diffusant diameter is greater than the pore diameter. These relationships suggest that another important aspect of diffusivity is the effective stiffness of the matrix and is of importance in both entry of the diffusing species to the dielectric volume and how the dielectric may slow or prevent further diffusion. This effective viscosity or stiffness includes contributions from the interaction with the diffusing species as well as matrix interactions, crosslink density, chain packing and alignment.

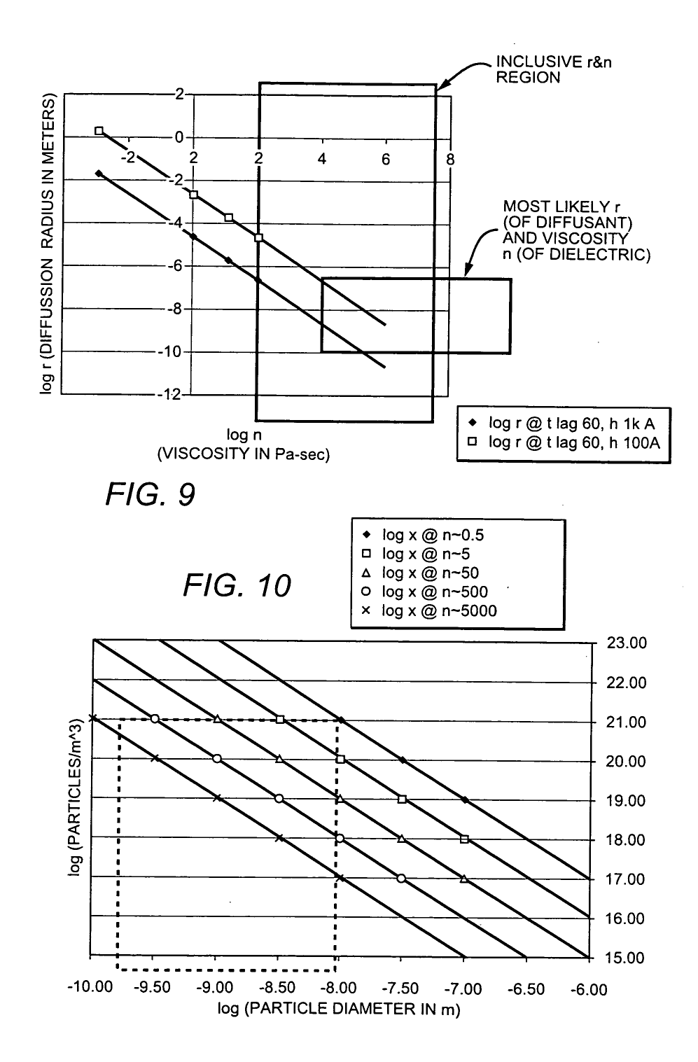

A suitable viscosity range can also be estimated, as it is known that, in a practical sense, the diameter of the diffusant must be larger than the pore diameter, and in a contemplated embodiment, there is a minimum process time at 700 k of 60 sec (lagtime) with a maximum feature size of 100 Å. That is, the theoretical lagtime ˜a²/6D where “a” is the feature size and the lagtime is at least 60 seconds. By comparing the diffusant and pore diameters it becomes apparent that the viscosity is probably greater than 100 Pa-sec (FIGS. 8 and 9).

A more realistic coefficient range has also been developed. According to modeling experiments, pores can be blocked against migration of adjacent atoms and/or molecules. So the change in diffusion coefficients and the matrix properties can be accounted for once a material configuration is established that is able to block migration by analyzing the theoretical relationships for an effective viscosity, which can be defined by an examination of conditions. Contemplated modeling experiments and modeling techniques can be those described in U.S. Pat. No. 6,544,650; U.S. patent application Ser. Nos. 10/326,233, 09/543,628, 10/113,461 and PCT Application Ser. No.: PCT/US03/07607, all of which are commonly-owned and incorporated herein in their entireties.

Combining the relationship between diffusion coefficient and viscosity with the definitions of defining the relationships between viscosity and mean-free path:
D=RT/N6πnr
n=ρcL/2
and
L=1/[(√2)π(2r)²x]
where
L=mean free path
r=particle radius
c=particle speed
n=viscosity
ρ=density
x=particle concentration
   Formulae n=ρc/[2(√2)π(2r)²x] and D=[2RT]/[N6πρc²rL] are generated, which result in theoretical relationships back to the simulation and describes the relationship between the diffusion coefficient, the viscosity, the particle speed and mean path and the particle concentration. The particle speed is based upon the model and the average particle velocity; and a critical particle concentration of 10¹⁵ atoms/cc for leakage current (see previously cited “Copper Contamination Induced Degradation of MOSFET Characteristics and Reliability”). So now a method is established to estimate what the effective viscosity should be if there is sufficient density within the matrix to stop migration based upon the argument of the mean free path. Examination of these relationships suggest that the diffusion coefficient must be less than 1×10⁻¹³ m²/sec for the particle diameter to be greater than or equal to the pore diameter and that there must be a corresponding “effective viscosity” of the dielectric. It also suggests that to get below critical concentration we must have a particle diameter range of 1-100 Å, and the effective viscosity might range anywhere greater than 0.5 Pa-sec, as shown in FIG. 10. Furthermore, modeling of copper migration through a 55 Å layer shows that copper atoms can have a maximum local velocity of 524 m/sec.

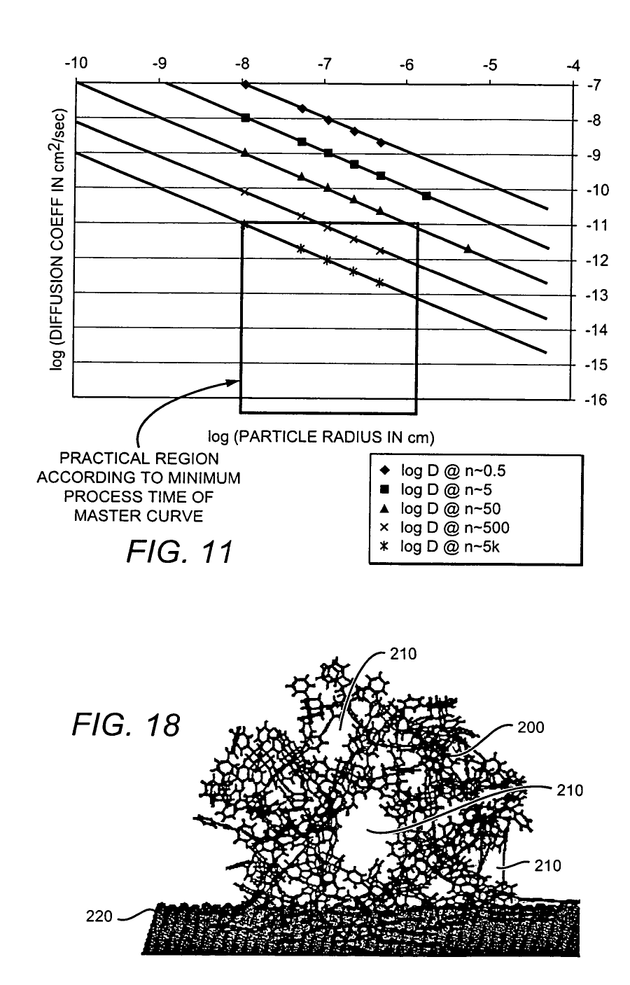

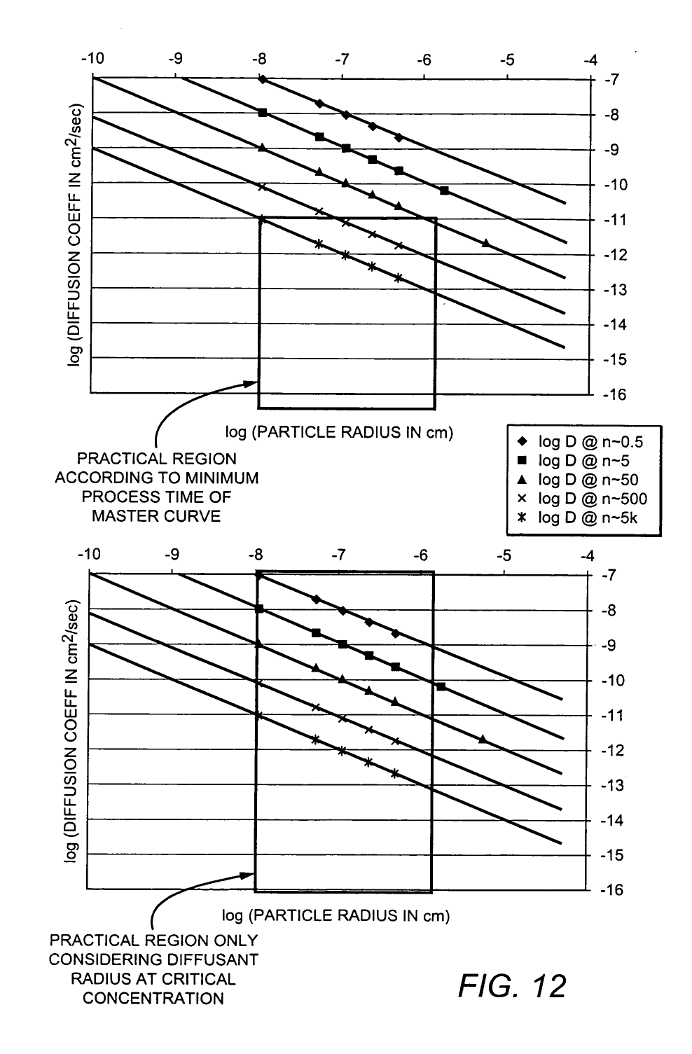

However, if reasonable process times and temperatures as discussed in the Background Section are to be maintained, then the diffusion coefficients must be even lower than 1×10⁻¹³ m²/sec and the effective viscosity really probably needs to be greater than 50 Pa-sec. This information is in rough agreement with the initial analysis, however for a much lower effective diffusion coefficient than estimated originally without consideration of particle concentration. These ranges are in a reasonable range for the diffusion coefficient as well as for the expected viscosity and target diffusant radii, as shown in FIG. 11. (See FIGS. 7 and 10-12)

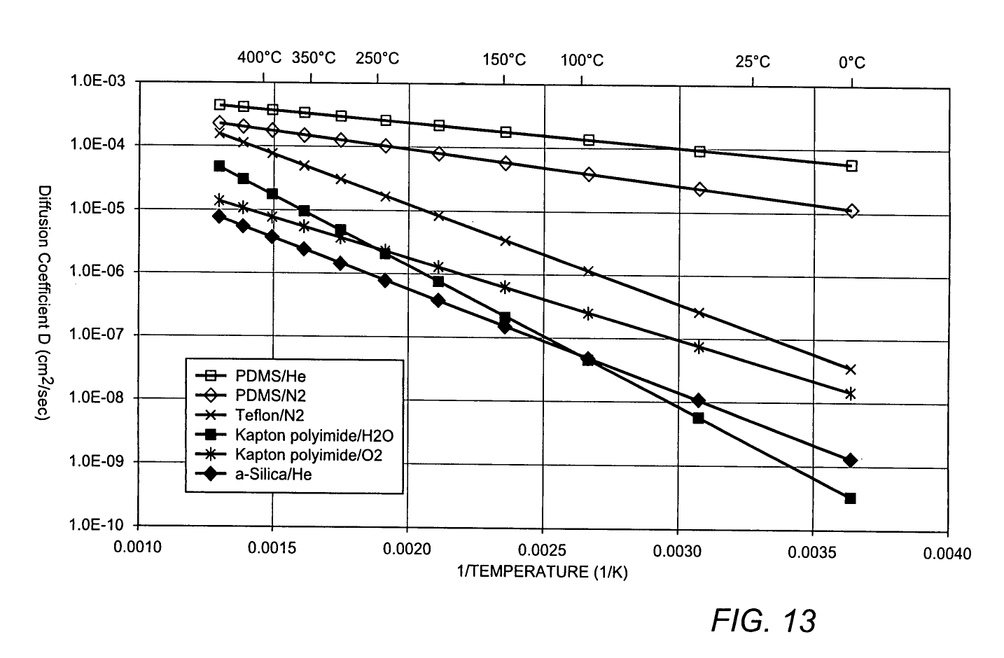

FIG. 13 shows a plot of the diffusion coefficient of a number of standard gases that can pass through polymeric materials and silica. The data indicates that there is about a 5 order of magnitude increase in diffusivity as the polymer is heated from room temperature to about 450° C. Even at 25° C., the gas diffusivity is so high that transport occurs through most solid polymeric materials in times substantially less than about 60 seconds.

For high temperature low k materials, such as organic polymers (polyimides), inorganic polymers (polysiloxanes, PDMS), or even amorphous silica, it is evident that small gas molecules can easily move through the materials during typical process times. Ironically, if this situation did not exist, it would be difficult to form porous low k dielectric materials utilizing a volatile porogen, used for pore formation, where the reaction product must rapidly leave the material. It is also possible that gases and other atomic species will flow through very thin (about 3 nm) barrier metals proposed for future use in semiconductor applications.

Using the information, equations and modeling experiments previously described and referenced herein, a layered component contemplated herein has been designed that comprises: a substrate; a dielectric material having a plurality of pores, wherein the material is coupled to the substrate; and a self-assembled diffusion blocking material coupled to the dielectric material, wherein the diffusion blocking material is physically attracted to the dielectric material. In other embodiments, a layered component contemplated herein has been designed that comprises: a substrate; a dielectric material having a plurality of pores, wherein the material is coupled to the substrate; and a self-assembled diffusion blocking material coupled to the dielectric material, wherein the diffusion blocking material reacts with the dielectric material. In yet other embodiments, a layered material is described that includes: a) a porous material comprising a porous surface; and b) a layer of blocking material comprising reactive functionalities coupled to the porous surface, wherein the interaction of the reactive functionalities with the porous material forms a diffusion blocking layer.

Methods are also described of minimizing the diffusion of metal atoms, reactive etchants or CVD/ALD precursor materials into a material having a plurality of pores are disclosed herein that include: a) providing a precursor material that comprises a carbon-including material; b) providing a solvent carrier solution; c) combining the precursor material and the solvent carrier solution to form a diffusion blocking reactive solution; and d) applying the diffusion blocking reactive solution to the material having a plurality of pores to form a diffusion blocking material.

The layered component contemplated herein may also comprise a diffusion blocking material that is not on the component in the form of a layer, but is instead being used to “block” the individual pores/voids and not to cover the entire underlying layer. In some embodiments, as mentioned, the diffusion blocking material will react at least partially or be attracted to with the underlying dielectric material or layer, and in other embodiments, the diffusion blocking material will not be reactive with the underlying dielectric material or layer at all.

The self-assembled diffusion blocking material may be a dense carbon-including material, such as graphite, diamond, a porphyrin layer, a siloxane polymer, a silsesquioxane compound, a multicyclic siloxane, a cyanine layer, a polyporphryin layer, a conductive polymer, a dense inorganic material, dense aromatic molecules or combinations thereof. In yet other embodiments the diffusion blocking material contemplated may consist of a densified layer of the material, a densified organic or inorganic polymer, or low k material or contain phase-separated elements of the material or low k material densified in such a manner as to block diffusion of species. In still other embodiments, whether reactive or non reactive, the blocking material may be self-assembled at the surface of the dielectric using surface energy (from both dielectric and blocking material), adsorption, absorption, solubility, adhesion/cohesion, and shape or molecular architecture of the blocking material and as mechanistic drivers.

In some embodiments, the diffusion blocking material may comprise a dense and rigid core of material that is surrounded by a dense and more flexible material and/or matrix. The rigid core of material may comprise any suitable material, such as a siloxane polymer, a silsesquioxane compound, a multicyclic siloxane, a multicyclic inorganic compound, such as carborane, aromatic compounds, such as porphyrins, annulenes, fullerenes, metallocene, cubenes, paracyclophanes, adamantanes, diamantanes or combinations of any of the herein mentioned suitable materials thereof.

The dense and more flexible material and/or matrix may comprise a long chain unit of organic and/or inorganic atoms and moieties. In some embodiments, the long chain unit contains at least three single bonds comprising the chain. Contemplated long chain units may comprise an alkane moiety, a long chain ketone moiety, a long chain ester moiety, a long chain alcohol moiety, a long chain amine moiety, a long chain thiol moiety, a polyoxyethylene, a polyoxymethylene, a polyalkene, a polyglycol, a polyaromatic ether, a polydimethylsiloxane, a polydialkylsiloxane, a polyalkylarylsiloxane or a combination thereof. The long chain unit may act as a capping moiety or may further comprise a capping moiety, such as those described herein.

In yet other embodiments, the dense and more flexible material and/or matrix may be capped by a reactive moiety or a reactive functionality. These capping and/or reactive moieties may comprise alkanes, esters, ketones, alcohols, thiols, aromatic species, alkenes, acids and/or acidic species, such as superacids, organic acids or combinations thereof, metal ligand compounds, CVD or ALD precursors, salts, such as ammonium fluoride salt, ammonium hydroxide salt or combinations thereof, photoinitiators, free radical initiators, basic species, such as metal hydrides, metal hydroxides or combinations thereof, crosslinkable functionalities or a combination thereof of any of the capping and/or reactive moieties mentioned herein. Capping moieties may be crosslinkable and as a result may undergo a crosslinking reaction with the underlying porous material, with itself in an intramolecular crosslinking reaction, or with another capping moiety.

In contemplated embodiments, the diffusion blocking materials are responsible for a significant decrease in migratory atoms and/or molecules when compared to a single-layer or layered component that does not comprise a diffusion blocking material coupled to a dielectric material and/or a low dielectric material. A significant decrease in migratory atoms and/or molecules is understood to mean at least about a 51% decrease in migratory atoms and/or molecules when compared to a single-layer or layered component that does not comprise a diffusion blocking material coupled to a dielectric material and/or a low dielectric material. In other contemplated embodiments, the diffusion blocking materials are responsible for at least about a 60% decrease in migratory atoms and/or molecules when compared to a single-layer or layered component that does not comprise a diffusion blocking material coupled to a dielectric material and/or a low dielectric material. In yet other contemplated embodiments, the diffusion blocking materials are responsible for at least about a 75% decrease in migratory atoms and/or molecules when compared to a single-layer or layered component that does not comprise a diffusion blocking material coupled to a dielectric material and/or a low dielectric material. In preferred embodiments, the diffusion blocking materials are responsible for at least about a 90% decrease in migratory atoms and/or molecules when compared to a single-layer or layered component that does not comprise a diffusion blocking material coupled to a dielectric material and/or a low dielectric material. In even more preferred embodiments, the diffusion blocking materials are responsible for at least about a 95% decrease in migratory atoms and/or molecules when compared to a single-layer or layered component that does not comprise a diffusion blocking material coupled to a dielectric material and/or a low dielectric material.

One of the more important concepts herein, however, is that the diffusion blocking materials, particles, molecules, layers or compounds can a) react or interact thru either bond or strong non-bond forces with the pore wall; b) diffuse into the pores and react or interact thru either bond or strong non-bond forces with the walls to decrease the pore diameter, and thus does not allow further diffusion of substances smaller than the new pore diameter; c) diffuse into the pore, expand in the pore to block the pore and thus cannot diffuse further themselves because of size; d) diffuse into the pore, expand inside the pore and react at or with the pore wall; e) reduce the effective pore diameter; f) block the pore and reduce the effective diffusion constant and/or g) a combination thereof. In some preferred embodiments, rigid molecules that are attached to rings are used. These molecules are thermally activated to obtain ring expansion (expansion in size). Ring-opening transformations would also be useful in several embodiments. In other preferred embodiments rigid core molecules attached to a layer(s) of highly branched chains may be used. The rigid core and branched structure are chosen so that no amount of thermal, mechanical or other force may adequately create accessible free space for diffusion. In other embodiments, a solution or dilute solution may be useful having particles and/or diffusion blocking material that has a size greater than the surface underlying pore diameter or the surface accessible free space.

It should also be appreciated that the diffusion blocking material or component can be designed to block the diffusion of gases, liquids, metals and additional unwanted materials from diffusing into the underlying layer or material. The gases, liquids, metals and other/additional unwanted materials may be deposited by any process generally used in electronic materials development and processing, including CVD/ALD (atomic layer deposition) depositions, liquid cleans and etches of dielectric materials, gaseous thermal processing and gas etching or even spin coating. If the diffusion blocking material is applied by a process separate to the dielectric material forming process, it may also be carried by any of these same processes used in electronic fabrication.

Surfaces contemplated herein may comprise any desirable substantially solid material, such as a substrate, wafer or other suitable surface. Particularly desirable substrate layers would comprise films, organic polymer, inorganic polymer, glass, ceramic, plastic, metal or coated metal, or composite material. Surface and/or substrate layers comprise at least one layer and in some instances comprise a plurality of layers. In some embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide. In other embodiments, the substrate comprises a material common in the integrated circuit industries as well as the packaging and circuit board industries such as silicon, copper, glass, inorganic silicates, aluminates, or another polymer. Suitable surfaces contemplated herein may also include another previously formed layered stack, other layered component, or other component altogether. An example of this may be where a dielectric material and CVD barrier layer are first laid down as a layered stack—which is considered the “surface” for the subsequently spun-on layered component.

At least one layer is coupled to the surface or substrate. As used herein, the term “coupled” means that the surface and layer or two layers are physically attached to one another or there's a physical attraction between two parts of matter or components, including bond forces such as covalent and ionic bonding, and non-bond forces such as Van der Waals, electrostatic, coulombic, hydrogen bonding and/or magnetic attraction. Also, as used herein, the term coupled is meant to encompass a situation where the surface and layer or two layers are directly attached to one another, but the term is also meant to encompass the situation where the surface and the layer or plurality of layers are coupled to one another indirectly—such as the case where there's an adhesion promoter layer between the surface and layer or where there's another layer altogether between the surface and layer or plurality of layers.

As used herein, the term “low dielectric constant” means a dielectric constant measured at 1 MHz to 2 GHz, unless otherwise inconsistent with context. It is contemplated that the value of the dielectric constant of a low dielectric constant material or layer is less than about 3. In a preferred embodiment, the value of a low dielectric constant material or layer is less than about 2.5. In a more preferred embodiment, the value of a dielectric constant material or layer is less than about 2.

Contemplated dielectric and low dielectric materials comprise inorganic-based compounds, such as silicon-based disclosed in commonly assigned U.S. Pat. No. 6,143,855 and pending U.S. Ser. No. 10/078,919 filed Feb. 19, 2002; (for example Honeywell International Inc. NANOGLASS® and HOSP® products), gallium-based, germanium-based, arsenic-based, boron-based compounds or combinations thereof, and organic-based compounds, such as polyethers, polyarylene ethers disclosed in commonly assigned U.S. Pat. No. 6,124,421 (such as Honeywell International Inc. FLARE™ product), polyimides, polyesters and adamantane-based or cage-based compounds disclosed in commonly assigned WO 01/78110 and WO 01/08308 (such as Honeywell International Inc. GX-3™ product). The dielectric and low dielectric materials may be applied by spin coating the material on to the surface, dip coating, spray coating, rolling the material on to the surface, dripping the material on to the surface, and/or spreading the material on to the surface.

As used herein, the phrases “spin-on material”, “spin-on organic material”, “spin-on composition” and “spin-on inorganic composition” may be used interchangeable and refer to those solutions and compositions that can be spun-on to a substrate or surface using the spin coating application process. It is further contemplated that the phrase “spin-on-glass materials” refers to a subset of “spin-on inorganic materials”, in that spin-on glass materials refer to those spin-on materials that comprise silicon-based compounds and/or polymers in whole or in part. Examples of silicon-based compounds comprise siloxane compounds, such as methylsiloxane, methylsilsesquioxane, phenylsiloxane, phenylsilsesquioxane, methylphenylsiloxane, methylphenylsilsesquioxane, silazane polymers, silicate polymers and mixtures thereof. A contemplated silazane polymer is perhydrosilazane, which has a “transparent” polymer backbone where chromophores can be attached.

As used herein, the phrase “spin-on-glass materials” also includes siloxane polymers and blockpolymers, hydrogensiloxane polymers of the general formula (H_{0-1.0}SiO_{1.5-2.0})ₓ and hydrogensilsesquioxane polymers, which have the formula (HSiO_{1.5})ₓ, where x is greater than about four. Also included are copolymers of hydrogensilsesquioxane and an alkoxyhydridosiloxane or hydroxyhydridosiloxane. Spin-on glass materials additionally include organohydridosiloxane polymers of the general formula (H_{0-1.0}SiO_{1.5-2.0})ₙ(R_{0-1.0}SiO_{1.5-2.0})ₘ, and organohydridosilsesquioxane polymers of the general formula (HSiO_{1.5})ₙ(RSiO_{1.5})ₘ, where m is greater than zero and the sum of n and m is greater than about four and R is alkyl or aryl. Some useful organohydridosiloxane polymers have the sum of n and m from about four to about 5000 where R is a C₁-C₂₀ alkyl group or a C₆-C₁₂ aryl group. The organohydridosiloxane and organohydridosilsesquioxane polymers are alternatively denoted spin-on-polymers. Some specific examples include alkylhydridosiloxanes, such as methylhydridosiloxanes, ethylhydridosiloxanes, propylhydridosiloxanes, t-butylhydridosiloxanes, phenylhydridosiloxanes; and alkylhydridosilsesquioxanes, such as methylhydridosilsesquioxanes, ethylhydridosilsesquioxanes, propylhydridosilsesquioxanes, t-butylhydridosilsequioxanes, phenylhydridosilsesquioxanes, and combinations thereof. Several of the contemplated spin-on materials are described in the following issued patents and pending applications, which are herein incorporated by reference in their entirety: (PCT/US00/15772 filed Jun. 8, 2000; U.S. application Ser. No. 09/330,248 filed Jun. 10, 1999; U.S. application Ser. No. 09/491,166 filed Jun. 10, 1999; U.S. Pat. No. 6,365,765 issued on Apr. 2, 2002; U.S. Pat. No. 6,268,457 issued on Jul. 31, 2001; U.S. application Ser. No. 10/001,143 filed Nov. 10, 2001; U.S. application Ser. No. 09/491,166 filed Jan. 26, 2000; PCT/US00/00523 filed Jan. 7, 1999; U.S. Pat. No. 6,177,199 issued Jan. 23, 2001; U.S. Pat. No. 6,358,559 issued Mar. 19, 2002; U.S. Pat. No. 6,218,020 issued Apr. 17, 2001; U.S. Pat. No. 6,361,820 issued Mar. 26, 2002; U.S. Pat. No. 6,218,497 issued Apr. 17, 2001; U.S. Pat. No. 6,359,099 issued Mar. 19, 2002; U.S. Pat. No. 6,143,855 issued Nov. 7, 2000; and U.S. application Ser. No. 09/611,528 filed Mar. 20, 1998).

Solutions of organohydridosiloxane and organosiloxane resins can be utilized for forming caged siloxane polymer films that are useful in the fabrication of a variety of electronic devices, micro-electronic devices, particularly semiconductor integrated circuits and various layered materials for electronic and semiconductor components, including hardmask layers, dielectric layers, etch stop layers and buried etch stop layers. These organohydridosiloxane resin layers are quite compatible with other materials that might be used for layered materials and devices, such as adamantane-based compounds, diamantane-based compounds, silicon-core compounds, organic dielectrics, and nanoporous dielectrics. Compounds that are considerably compatible with the organohydridosiloxane resin layers contemplated herein are disclosed in PCT Application PCT/US01/32569 filed Oct. 17, 2001; PCT Application PCT/US01/50812 filed Dec. 31, 2001; U.S. application Ser. No. 09/538,276; U.S. application Ser. No. 09/544,504; U.S. application Ser. No. 09/587,851; U.S. Pat. No. 6,214,746; U.S. Pat. No. 6,171,687; U.S. Pat. No. 6,172,128; U.S. Pat. No. 6,156,812, U.S. Application Ser. No. 60/350,187 filed Jan. 15, 2002; and U.S. 60/347,195 filed Jan. 8, 2002, which are all incorporated herein by reference in their entirety.

Organohydridosiloxane resins utilized herein have the following general formulas:
[H—Si_{1.5}]ₙ[R—SiO_{1.5}]ₘ Formula (1)
[H_{0.5}—Si_{1.5-1.8}]ₙ[R_{0.5-1.0}—SiO_{1.5-1.8}]ₘ Formula (2)
[H_{0-1.0}—Si_{1.5}]ₙ[R—SiO_{1.5}]ₘ Formula (3)
[H—Si_{1.5}]ₓ[R—SiO_{1.5}]_{y}[SiO₂]_{z} Formula (4)
wherein:

the sum of n and m, or the sum or x, y and z is from about 8 to about 5000, and m or y is selected such that carbon containing constituents are present in either an amount of less than about 40 percent (Low Organic Content=LOSP) or in an amount greater than about 40 percent (High Organic Content=HOSP); R is selected from substituted and unsubstituted, normal and branched alkyls (methyl, ethyl, butyl, propyl, pentyl), alkenyl groups (vinyl, allyl, isopropenyl), cycloalkyls, cycloalkenyl groups, aryls (phenyl groups, benzyl groups, naphthalenyl groups, anthracenyl groups and phenanthrenyl groups), and mixtures thereof; and wherein the specific mole percent of carbon containing substituents is a function of the ratio of the amounts of starting materials. In some LOSP embodiments, particularly favorable results are obtained with the mole percent of carbon containing substituents being in the range of between about 15 mole percent to about 25 mole percent. In some HOSP embodiments, favorable results are obtained with the mole percent of carbon containing substituents are in the range of between about 55 mole percent to about 75 mole percent.

Nanoporous silica dielectric films with dielectric constants ranging from about 1.5 to about 4 can be also as at least one of the layers. Nanoporous silica compounds contemplated herein are those compounds found in Issued U.S. Pat. Nos. 6,022,812; 6,037,275; 6,042,994; 6,048,804; 6,090,448; 6,126,733; 6,140,254; 6,204,202; 6,208,041; 6,318,124 and 6,319,855. These types of films are laid down as a silicon-based precursor, aged or condensed in the presence of water and heated sufficiently to remove substantially all of the porogen and to form voids in the film. The silicon-based precursor composition comprises monomers or prepolymers that have the formula: Rₓ—Si-L_{y}, wherein R is independently selected from alkyl groups, aryl groups, hydrogen and combinations thereof, L is an electronegative moiety, such as alkoxy, carboxy, amino, amido, halide, isocyanato and combinations thereof, x is an integer ranging from 0 to about 2, and y is an integer ranging from about 2 to about 4. Other nanoporous compounds and methods can be found in Issued U.S. Pat. Nos. 6,156,812; 6,171,687; 6,172,128; 6,214,746; 6,313,185; 6,380,347; and 6,380,270, which are incorporated herein in their entirety.

The phrases “cage structure”, “cage molecule”, and “cage compound” are intended to be used interchangeably and refer to a molecule having at least 10 atoms arranged such that at least one bridge covalently connects two or more atoms of a ring system. In other words, a cage structure, cage molecule or cage compound comprises a plurality of rings formed by covalently bound atoms, wherein the structure, molecule or compound defines a volume, such that a point located with the volume can not leave the volume without passing through the ring. The bridge and/or the ring system may comprise one or more heteroatoms, and may be aromatic, partially saturated, or unsaturated. Further contemplated cage structures include fullerenes, and crown ethers having at least one bridge. For example, an adamantane or diamantane is considered a cage structure, while a naphthalene compound or an aromatic spirocompound are not considered a cage structure under the scope of this definition, because a naphthalene compound or an aromatic spirocompound do not have one, or more than one bridge.

Contemplated cage compounds need not necessarily be limited to being comprised solely of carbon atoms, but may also include heteroatoms such as N, S, O, P, etc. Heteroatoms may advantageously introduce non-tetragonal bond angle configurations. With respect to substituents and derivatizations of contemplated cage compounds, it should be recognized that many substituents and derivatizations are appropriate. For example, where the cage compounds are relatively hydrophobic, hydrophilic substituents may be introduced to increase solubility in hydrophilic solvents, or vice versa. Alternatively, in cases where polarity is desired, polar side groups may be added to the cage compound. It is further contemplated that appropriate substituents may also include thermolabile groups, nucleophilic and electrophilic groups. It should also be appreciated that functional groups may be employed in the cage compound (e.g., to facilitate crosslinking reactions, derivatization reactions, etc.) Where the cage compounds are derivatized, it is especially contemplated that derivatizations include halogenation of the cage compound, and a particularly preferred halogen is fluorine.

Cage molecules or compounds, as described in detail herein, can also be groups that are attached to a polymer backbone, and therefore, can form nanoporous materials where the cage compound forms one type of void (intramolecular) and where the crosslinking of at least one part of the backbone with itself or another backbone can form another type of void (intermolecular). Additional cage molecules, cage compounds and variations of these molecules and compounds are described in detail in PCT/US01/32569 filed on Oct. 18, 2001, which is herein incorporated by reference in its entirety.

Contemplated polymers may also comprise a wide range of functional or structural moieties, including aromatic systems, and halogenated groups. Furthermore, appropriate polymers may have many configurations, including a homopolymer, and a heteropolymer. Moreover, alternative polymers may have various forms, such as linear, branched, super-branched, or three-dimensional. The molecular weight of contemplated polymers spans a wide range, typically between 400 Dalton and 400000 Dalton or more.

The organic and inorganic materials described herein are similar in some respects to those which are described in U.S. Pat. No. 5,874,516 to Burgoyne et al. (February 1999), incorporated herein by reference, and may be used in substantially the same manner as set forth in that patent. For example, it is contemplated that the organic and inorganic materials described herein may be employed in fabricating electronic chips, chips, and multichip modules, interlayer dielectrics, protective coatings, and as a substrate in circuit boards or printed wiring boards. Moreover, films or coatings of the organic and inorganic materials described herein can be formed by solution techniques such as spraying, spin coating or casting, with spin coating being preferred. Preferred solvents are 2-ethoxyethyl ether, cyclohexanone, cyclopentanone, toluene, xylene, chlorobenzene, N-methyl pyrrolidinone, N,N-dimethylformamide, N,N-dimethylacetamide, methyl isobutyl ketone, 2-methoxyethyl ether, 5-methyl-2-hexanone, γ-butyrolactone, and mixtures thereof. Typically, the coating thickness is between about 0.1 to about 15 microns. As a dielectric interlayer, the film thickness is less than 2 microns.

Additives can also be used to enhance or impart particular target properties, as is conventionally known in the polymer art, including stabilizers, flame retardants, pigments, plasticizers, surfactants, and the like. Compatible or non-compatible polymers can be blended in to give a desired property. Adhesion promoters can also be used. Such promoters are typified by hexamethyidisilazane, which can be used to interact with available hydroxyl functionality that may be present on a surface, such as silicon dioxide, that was exposed to moisture or humidity. Polymers for microelectronic applications desirably contain low levels (generally less than 1 ppm, preferably less than 10 ppb) of ionic impurities, particularly for dielectric interlayers.

As used herein, the term “crosslinking” refers to a process in which at least two molecules, or two portions of a long molecule, are joined together by a chemical interaction. Such interactions may occur in many different ways including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

As mentioned earlier, some preferred embodiments comprise a plurality of voids and/or pores in one or all of the dielectric layers or low dielectric constant layers. This plurality of voids can also be expressed by using the phrase “nanoporous layer” or “ultrananoporous layer”. As used herein, the term “nanoporous layer” refers to any suitable low dielectric material (i.e. ≦3.0) that is composed of a plurality of voids and a non-volatile component. As used herein, the term “substantially” means a desired component is present in a layer at a weight percent amount greater than 51%. A layered material herein described also comprises: a) a dielectric material having a plurality of pores, wherein each pore has a pore diameter; and b) a layer comprising a plurality of particles, wherein the particles have a particle size that is larger than the pore diameter.

Incorporating or introducing porogens into the dielectric materials can form the plurality of pores and/or voids. At least one porogen may be added to the dielectric material and/or layer. The pores or voids may be formed as a result of structural rearrangement or loss of material such that a pore or void or increase in free volume is left behind.

As used herein, the term “pore” includes voids and cells in a material and any other term meaning space. The term “pore” may also include a differential in material density wherein the free volume has been increased (“porous nature” has been introduced). Appropriate gases include relatively pure gases and mixtures thereof. Air, which is predominantly a mixture of N₂ and O₂ is commonly distributed in the pores, but pure gases such as nitrogen, helium, argon, CO₂ or CO are also contemplated. Pores are typically spherical but may alternatively or additionally include tubular, lamellar, discoidal, voids having other shapes, or a combination of the preceding shapes and may be open or closed. The term “porogen” as used herein may have a variety of mechanisms available to form the pore but in general is a material, which upon removal, leaves behind either a “pore” or a “void” or a material that can rearrange to create a “pore” or “void”. In one embodiment, a porogen is a decomposable material that is radiation, thermally, chemically or moisture decomposable, degradable, depolymerizable or otherwise capable of breaking down and includes solid, liquid or gaseous material.

The decomposed porogen is removable from or can volatilize or diffuse through a partially or fully cross-linked matrix to create pores in a subsequently fully-cured matrix and thus, lower the matrix's dielectric constant and enhance the sacrificial properties. In another embodiment, the porogen might be a material, which does not decompose but can be dissolved out of the matrix leaving behind the “pore”. In a third embodiment the porogen might be a material that does not decompose but is volatile enough to dissipate at specific elevated temperatures such as in the 250-350° C. range. Supercritical materials, such as CO₂, may be used to remove the porogen and decomposed porogen fragments. Preferably, for a thermally decomposable porogen, the porogen comprises a material having a decomposition temperature greater than the minimum crosslinking temperature of the material. Preferably, the present novel porogens have a degradation or decomposition temperature of up to about 300° C., and in some cases greater than about 300° C. Preferably, the degraded or decomposed porogens volatilize at a temperature greater than the minimum cross-linking temperature of the material with which the porogen is combined. Preferably, the degraded or decomposed porogens volatilize at a temperature between about 500 to about 450° C.

Although International Patent Publication WO 00/31183 teaches that a porogen may be added to thermosettable benzocyclobutene, polyarylene or thermosettable perfluoroethylene monomer to increase porosity thereof and thus, lower the dielectric constant of that resin, the reference teaches that a porogen that is known to function well with a first matrix system will not necessarily function well with another matrix system.

Known porogens, such as linear polymer, star polymers, cross-linked polymeric nanospheres, block copolymers, and hyperbranched polymers may be used in contemplated embodiments with the inorganic-based compounds and materials. Suitable linear polymers are polyethers, such as poly(ethylene oxide) and poly(propylene oxide); polyacrylates such as poly(methylmethacrylate); aliphatic polycarbonates such as poly(propylene carbonate) and poly(ethylene carbonate); polyesters; polysulfones; polystyrene (including monomer units selected from halogenated styrene and hydroxy-substituted styrene); poly(α-methylstyrene); and other vinyl-based polymers. Useful polyester porogens include polycaprolactone; polyethylene terephthalate; poly(oxyadipoyloxy-1,4-phenylene); poly(oxyterephthaloyloxy-1,4-phenylene); poly(oxyadipoyloxy-1,6-hexamethylene); polyglycolide, polylactide (polylactic acid), polylactide-glycolide, polypyruvic acid, polycarbonate such as poly(hexamethylene carbonate) diol having a molecular weight from about 500 to about 2500; and polyether such as poly(bisphenol A-co-epichlorohydrin) having a molecular weight from about 300 to about 6500. Suitable crosslinked, insoluble nanospheres (prepared as nanoemulsions) are suitably comprised of polystyrene or poly(methylmethacrylate). Suitable block copolymers are poly-gylcolids, polylactic acid, poly(styrene-co-α-methylstyrene, poly(styrene-ethylene oxide), poly(etherlactones), poly(estercarbonates) and poly(lactonelactide). Suitable hyperbranched polymers are hyperbranched polyester, e.g. hyperbranched poly(caprolactone), and polyethers such as polyethylene oxide and polypropylene oxide. Another useful porogen is ethylene glycol-poly(caprolactone). Useful polymer blocks include polyvinylpyridines, hydrogenated polyvinyl aromatics, polyacrylonitriles, polysiloxanes, polycaprolactams, polyurethanes, polydienes such as polybutadienes and polyisoprenes, polyvinyl chlorides, polyacetals and amine-capped alkylene oxides. Other useful thermoplastic materials include polyisoprenes, polytetrahydrofurans and polyethyloxazolines.

Other suitable porogens suitable for use in contemplated embodiments include polymers, preferably those which contain one or more reactive groups, such as hydroxyl or amino. Within these general parameters, a suitable polymer porogen for use in the compositions and methods disclosed herein is, e.g. a polyalkylene oxide, a monoether of a polyalkylene oxide, a diether of a polyalkylene oxide, bisether of a polyalkylene oxide, an aliphatic polyester, an acrylic polymer, an acetal polymer, a poly(caprolactone), a poly(valeractone), a poly(methlymethoacrylate), a poly(vinylbutyral) and/or combinations thereof. When the porogen is a polyalkylene oxide monoether, one particular embodiment is a C₁ to about C₆ alkyl chain between oxygen atoms and a C₁ to about C₆ alkyl ether moiety, and wherein the alkyl chain is substituted or unsubstituted, e.g., polyethylene glycol monomethyl ether, polyethylene glycol dimethyl ether, or polypropylene glycol monomethyl ether.

Porogens comprising at least two fused aromatic rings wherein each of the fused aromatic rings has at least one alkyl substituent thereon and a bond exists between at least two of the alkyl substituents on adjacent aromatic rings may be used in contemplated embodiments. Preferred porogens include unfunctionalized polyacenaphthylene homopolymer, functionalized polyacenaphthylene homopolymer, the polyacenaphthylene copolymers described below, poly(2-vinylnaphthalene) and vinyl anthracene, and blends with each other. Other useful porogens include adamantane, diamantane, fullerene and polynorbornene. Each of these porogens, including those listed above, may be blended with one another or other porogen material, such as polycaprolactone, polystyrene and polyester. Useful blends include unfunctionalized polyacenaphthylene homopolymer and polycaprolactone. The more preferred porogens are unfunctionalized polyacenaphthylene homopolymer, functionalized polyacenaphthylene homopolymer, polyacenaphthylene copolymer and polynorbornene.

Useful polyacenaphthylene homopolymers may have weight average molecular weights ranging from preferably about 300 to about 20,000; more preferably about 300 to about 10,000; and most preferably about 1000 to about 7000 and may be polymerized from acenaphthylene using different initiators such as 2,2′-azobisisobutyronitrile (AIBN); di-tert-butyl azodicarboxylate; di-phenylazodicarboxylate; 1,1′-azobis(cyclohezanecarbonitrile); benzoyl peroxide (BPO); t-butyl peroxide; and boron trifluoride diethyl etherate. The polyacenaphthylene homopolymer may have functional end groups such as triple bonds or double bonds to the chain end or cationic polymerization quenched with a double or triple bond alcohol, such as allyl alcohol, propargyl alcohol, butynol, butenol or hydroxyethylmethacrylate.

European Patent Publication 315453 teaches that silica and certain metal oxides may react with carbon to form volatile suboxides and gaseous carbon oxide to form pores and teaches that sources of carbon include any suitable organic polymer including polyacenaphthylene. However, the reference does not teach or suggest that polyacenaphthylene is a porogen useful in non-metallic materials or in reducing the dielectric constant of a matrix or increasing the etch selectivity of a dielectric material.

Useful polyacenaphthylene copolymers may be linear polymers, star polymers or hyperbranched polymers. The comonomer may have a bulky side group that will result in copolymer conformation that is similar to that of polyacenaphthylene homopolymer or a nonbulky side group that will result in copolymer conformation that is dissimilar to that of polyacenaphthylene homopolymer. Comonomers having a bulky side group include vinyl pivalate; tert-butyl acrylate; styrene; α-methylstyrene; tert-butylstyrene; 2-vinylnaphthalene; 5-vinyl-2-norbornene; vinyl cyclohexane; vinyl cyclopentant; 9-vinylanthracene; 4-vinylbiphenyl; tetraphenylbutadiene; stilbene; tert-butylstilbene; and indene; and preferably vinyl pivalate. Hydridopolycarbosilane may be used as an additional co-monomer or copolymer component with acenaphthylene and at least one of the preceding comonomers. An example of a useful hydridopolycarbosilane has 10% or 75% allyl groups. Comonomers having a nonbulky side group include vinyl acetate, methyl acrylate, methyl methacrylate, and vinyl ether and preferably vinyl acetate.

When discussing pore generation, the term “degrade” refers to the breaking of covalent bonds. Such breaking of bonds may occur in numerous ways including heterolytic and homolytic breakage. The breaking of bonds need not be complete, i.e., not all breakable bonds must be cleaved. Furthermore, the breaking of bonds may occur in some bonds faster than in others. Ester bonds, for example, are generally less stable than amide bonds, and therefore, are cleaved at a faster rate. Breakage of bonds may also result in the release of fragments differing from one another, depending on the chemical composition of the degraded portion.

In a preferred embodiment of the pore generation process, for thermally degradable porogens, thermal energy is applied to the porogen containing material to substantially degrade or decompose the porogen into its starting components or monomers. As used herein, “substantially degrade” preferably means at least about 40 weight percent of the porogen degrades or decomposes. In more preferred embodiments, at least about 50 weight percent of the porogen degrades or decomposes, and in most preferred embodiments, at least about 80 weight percent of the porogen degrades or decomposes. In another embodiment, the porogen is dissolved out in either a separate process stage or in combination with other stages of process, such as during the photolithography development or during the actual wet stripping of the porogen containing material.

Any suitable procedure or condition may be used to remove or at least partially remove the at least one porogen, including heat, dissolution in solvents, preferential etching, exposure to radiation, electromagnetic radiation, such as ultraviolet, x-ray, laser or infrared radiation; mechanical energy, such as sonication or physical pressure; or particle radiation, such as gamma ray, alpha particles, neutron beam or electron beam as taught by commonly assigned patent publication PCT/US96/08678 and U.S. Pat. Nos. 6,042,994; 6,080,526; 6,177,143; and 6,235,353, which are incorporated herein by reference in their entireties.

The materials, precursors and layers described herein can be and in many ways are designed to be solvated or dissolved in any suitable solvent, so long as the resulting solutions can be applied to a substrate, a surface, a wafer or layered material. Typical solvents are also those solvents that are able to solvate the monomers, isomeric monomer mixtures and polymers. Contemplated solvents include any suitable pure or mixture of organic or inorganic molecules that are volatilized at a desired temperature, such as the critical temperature, or that can facilitate any of the above-mentioned design goals or needs. The solvent may also comprise any suitable pure or mixture of polar and non-polar compounds. As used herein, the term “pure” used with respect to a solvent means a solvent that comprises a single constituent. For example, pure water is composed solely of H₂O. The term “pure” as used herein is not referring to the level of impurities, but is instead referring to the selected solvent as comprising one solvent component or constituent, as opposed to a solvent mixture. As used herein, the term “mixture” used with respect to a solvent means a solvent that comprises at least two constituents, for example—salt water, which comprises salt and water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound.

In some contemplated embodiments, the solvent or solvent mixture (comprising at least two solvents) comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine. Particularly contemplated solvents include, but are not limited to, pentane, hexane, heptane, cyclohexane, benzene, toluene, xylene and mixtures or combinations thereof.

In other contemplated embodiments, the solvent or solvent mixture may comprise those solvents that are not considered part of the hydrocarbon solvent family of compounds, such as ketones, such as acetone, diethyl ketone, methyl ethyl ketone and the like, alcohols, esters, water, ethers and amines. In yet other contemplated embodiments, the solvent or solvent mixture may comprise a combination of any of the solvents mentioned herein.

In some embodiments, the solvent comprises water, ethanol, propanol, acetone, ethylene oxide, benzene, toluene, ethers, cyclohexanone, butyrolactone, methylethylketone, and anisole. In other embodiments, no solvent is used and at least one liquid monomer is chosen to form a solventless formulation.

It is still further contemplated that alternative low dielectric constant material may also comprise additional components. For example, where the low dielectric constant material is exposed to mechanical stress, softeners or other protective agents may be added. In other cases where the dielectric material is placed on a smooth surface, adhesion promoters may advantageously employed. In still other cases, the addition of detergents or antifoam agents may be desirable.

The diffusion blocking material may also comprise any material that may form a dense layer, such as found in polyaromatics (such as graphite), diamond-like carbon, the porphyrin family (such as phthalocyanines) and polymers of porphyrins, the cyanine family, the multiolefin family, the cyclo-olefin family, or the acetylide family. For instance, in the spirit of molecules that may orient, chain align and densify, the diffusion blocking material may be of a conductive polymer class such as but not limited to a polythiophene moiety, a polyacetylene moiety, a polypyrrole moiety, a polypyridine moiety, a polyaniline moiety or a combination thereof. The polymeric materials mentioned are expected to have low diffusivities due to high local chain viscosity (or “effective viscosity”) directly related to the high density, high packing and/or crystallinity, and high chain or functional group component rigidity. In addition, all of these structures are capable of being oriented to high packing densities, which increase the interfacial density and lower the diffusivity of the film. An example of a material with the highest density in conjunction with highest “effective viscosity” or highest “effective stiffness” is the diamond structure due to the highest possible crosslinking for a carbon-containing material which contributes to both density and stiffness. Graphite would be an example of a material with a high potential interfacial density, depending upon defect structure. In addition, it's effective stiffness would depend upon how the graphitic the carbon layer may be, the morphology of the film, as well as how defect free the film is made. Local defects would contribute greatly to a loss film density and contribute to cracks or voids.

The diffusion blocking material may also comprise at least one CVD precursor material. The diffusion blocking material may also comprise at least one ligand and/or chelating agent. The ligand may comprise any suitable ligand-forming group, such as those found in the porphyrin family (phthalocyanines), the cyanine family, the multiolefin family, the cyclo-olefin family, or the acetylide family. For instance, in the spirit of molecules that may orient, chain align and densify and still have functionalities that can ligate to a metal, the diffusion blocking material may be of a conductive polymer class such as but not limited to a polythiophene moiety, a polyacetylene moiety, a polypyrrole moiety, a polypyridine moiety, a polyaniline moiety or a combination thereof.

The diffusion blocking material may also comprise at least one liquid crystal material, polyaromatic or conductive polymer such as a polythiophene moiety, a polyacetylene moiety, a polypyrrole moiety, a polypyridine moiety, a polyaniline moiety or a combination thereof. In addition the diffusion blocking material may contain any type of fused polyarylene such as corenes, perylenes, benzoperylenes, rubrenes, pyrenes, pentacenes, benzofluorenes and similar fused arylenes of sufficient size. The ligand may also be coupled to a metal atom. As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include indium, silver, copper, aluminum, tin, bismuth, gallium, silicon, titanium, tantalum, hafnium, ruthenium, and alloys thereof, silver coated copper, and silver coated aluminum. The term “metal” also includes alloys, metal/metal composites, metal ceramic composites, metal polymer composites, as well as other metal composites. As used herein, the term “compound” means a substance that can be broken down into smaller molecules and/or atoms by chemical or physical processes.

In some embodiments where there are bare metal lines or metal regions on a surface or substrate, a self-assembled diffusion barrier layer may be formed by a) depositing a ligating agent, such as sodium cyclopentadienide, pthalocyanine, etc, directly on the metal where it reacts with the metal to form a ligand-metal couple or metal-chelate. Any excess may be washed off of the surface after formation of the ligand-metal couple or metal chelate. In the case where copper is the surface metal, the ligating agent may react directly with the surface copper oxide to create a copper catalyst. In other embodiments, a metal solution of a metal catalyst, such as nickel, cobalt or iron, may be deposited, wherein any excess metal solution is rinsed off of the surface. Once the metal catalyst is deposited, graphite may be deposited by CVD deposition. In optional embodiments, the metal cap that forms may be removed and a layer buildup can be continued. In these embodiments, the ligand should only be attracted to the metal surface, and as such, can be considered self-assembly.

The plurality of particles may comprise at least one ligand-metal couple. The ligand-metal couple may comprise copper. It is contemplated that the plurality of particles are physically attracted to the dielectric material. It is further contemplated that the plurality of particles forms a stop layer. The stop layer is designed to decrease a diffusion of metal atoms into the dielectric material by at least 25%, by at least about 50% and by at least about 75%, depending on the material chosen for the stop layer.

In some contemplated embodiments, a self-assembled diffusion barrier layer may be formed from a graphite-like or diamond-like layer by a) depositing a metal or the metal-ligand couple on a surface or substrate, wherein the metal or the couple serves as a catalyst for carbon deposition; b) depositing a carbon-including composition, such as graphitic carbon (deposited by CVD), or diamond-like carbon, as a barrier layer; and c) optionally removing the metal cap which forms from the metal catalyst. The metal-ligand couple may be deposited by either spin-on deposition techniques, CVD or ALD. The metal may be deposited by CVD, ALD, PVD or other methods known to the industry. In these embodiments, a fully dense carbon layer (graphite or diamond) is formed only on the metal-containing areas without any separate masking required. In some embodiments, as described, the metal or metal-ligand couple may be deposited on a surface or substrate. In other contemplated embodiments, the ligand and metal ion may be deposited on a surface or substrate separately in order to create a catalyst for carbon deposition. Once the catalyst forms, a carbon-including composition, such as graphite, is deposited (by CVD, for example). The metal cap may be removed from the surface. Copper metallization and additional layer buildups may be performed.

Layered materials contemplated herein may also comprise a dielectric material having a plurality of pores, wherein each pore has a pore diameter; and a layer having a plurality of particles or merely a plurality of particles, wherein the plurality of particles have a particle size that is or can become larger than the pore diameter.

A method of minimizing the diffusion of metal or diffusible atoms and/or molecules into a material having a plurality of pores is also described herein, wherein the method comprises: a) providing a precursor material that comprises molecules having a molecule size that is larger than a pore diameter of any one of the plurality of pores; b) providing a solvent carrier solution; c) combining the precursor material and the solvent carrier solution to form a diffusion blocking reactive solution; and d) applying the diffusion blocking reactive solution to the material having a plurality of pores. Another embodiment provides a precursor material whose molecular size is smaller than a pore diameter, but able to expand to block the pore after having been applied by the reactive solution and activated after application, during process where this process may be defined as thermal or chemical treatment or a combination of both thermal and chemical treatments.

An additional embodiment provides a material with a main body of molecular size that is larger than the pore, but with functionalities on the outer surface of the molecule terminated or capped by reactive groups such as amines, acids, photoinitiators, organometallics (CVD or ALD precursors materials), polymerizable reactive groups and crosslinking groups such as acrylates, isocyanates, cyanate esters, epoxies, silanes, vinyls, acetylenes, and other polymerizable species that will crosslink by themselves or to the matrix. In one example of this embodiment the reactive groups may be used to enhance self assembly properties, by containing functionalities that are specifically attracted to or bond with just the surface. An example of such self assembly character might be an outer surface termination of alkoxysilyl groups that are specific only for reaction with silanols on the surface of a low k silica dielectric. In another example of this embodiment the reactive groups may be used to further crosslink the molecules to a layer. In another example, the reactive groups may be used to react to the surface to form a layer and to further density the molecule layer. In still another example of this embodiment the reactive groups may be used for both self assembly and layer crosslinking.

In another example of this embodiment the layer the capping moiety is tethered from the main body of the molecule by a long chain. After reaction the material may or may not be removed depending upon the application. In one example of this concept, a crosslinking agent such as an epoxy, an acrylate, a urethane, an isocyante, a silane (such as a di or trialkoxy, di or triarloxy, a di or triacetoxy) is allowed to react to permanently react, effectively blocking the immediate surface of the pore with the main body of the pore blocker. In another example of the concept, the main body of the molecule is used in a sacrificial manner to control diffusion of a specific reactant into the immediate surface of the dielectric by allowing penetration of the reactant into a pore limited by the length of the long chain tether. As an example of this sacrificial application, a reactive crosslinkable group that is compatible with the dielectric chemistry is tethered to the long chain functionality by a hydrolyzable or a cleavable functionality such as an organic ester or a silyl ether. An example of compatible chemistry might be a tethered alkoxysilyl group on the molecule that might react with the silanol functionalities on a silica-based dielectric. Upon reaction of the crosslinkable group the pore opening is blocked or sealed and upon reaction or hydrolysis of the ester or silyl ether the main body of the molecule is released and removed with a rinse. In another example of this sacrificial application, the alkoxysilyl group might be further functionalized to change the surface energy of the pore surface. For instance the alkoxysilyl group may also contain an organic functionality which lowers the surface energy of the surface. In another example of a sacrificial molecule, the main body of the molecule contains a long chain terminated with an amine fluoride salt. This salt is allowed to penetrate a pore to the depth of the long chain tether, react with the silica matrix around it, thus increasing it the etch sensitivity of the immediate surface, and the entire molecule removed with a solvent rinse. The surface is then primed for higher etch character. In another example of this application, a free radical or photoinitiator such is allowed to initiate crosslinking of unreacted olefinic groups in the dielectric to further densify the surface of the dielectric, and the entire molecule is removed with a rinse. The densified surface will be more resistant to diffusion. The densified surface may also be more resistant to etch chemistries. In other embodiments, a free radical or photoinitiator and the reactive species are tethered to the same molecule. In other embodiments, the free radical or photoinitiator and the reactive species are tethered on different molecules. An additional embodiment provides a precursor material of the same characteristics described above, but capable of CVD deposition.

These embodiments are meant to illustrate examples in which diffusion of the reactive species is prohibited by a large blocking group, and in which chemistry can be done at the immediate surface without fear of penetration and further reaction deeper into a material, even if it is porous material.

Still additional embodiments of minimizing the diffusion of metal or diffusible atoms and/or molecules into a material comprise those methods found in Issued U.S. Pat. No. 6,544,650 issued on Apr. 8, 2003 and U.S. patent application Ser. Nos. 10/326,233 filed on Dec. 19, 2002; 09/543,628 filed on Apr. 5, 2000; and 10/113,461 filed on Mar. 28, 2002, which are commonly assigned to Honeywell International, Inc. and which are incorporated herein in their entirety.

Additional layers of material may be coupled to the layered interface materials in order to continue building a layered component or printed circuit board. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

A layer of laminating material or cladding material can be coupled to the layered interface materials depending on the specifications required by the component. Laminates are generally considered fiber-reinforced resin dielectric materials. Cladding materials are a subset of laminates that are produced when metals and other materials, such as copper, are incorporated into the laminates. (Harper, Charles A., Electronic Packaging and Interconnection Handbook, Second Edition, McGraw-Hill (New York), 1997.)

Spin-on layers and materials may also be added to the layered interface materials or subsequent layers. Spin-on stacked films are taught by Michael E. Thomas, “Spin-On Stacked Films for Low k_{eff} Dielectrics”, Solid State Technology (July 2001), incorporated herein in its entirety by reference.

Examples of other additional layers of materials comprise metals (such as those which might be used to form via fills or printed circuits and also those included in U.S. Pat. Nos. 5,780,755; 6,113,781; 6,348,139 and 6,332,233 all of which are incorporated herein in their entirety), metal diffusion layers, mask layers, anti-reflective coatings layers, adhesion promoter layers and the like.

Applications of the contemplated layered materials or components described herein comprise incorporating the materials and/or components into another layered material, an electronic component or a finished electronic product and/or modifying the chemistry of a layered material. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors. An electronic component or a semiconductor component may comprise a contemplated layered component described herein.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

As used herein, the term “electronic component” means any device or part that can be used in a circuit to obtain some desired electrical action. Electronic components contemplated herein may be classified in many different ways, including classification into active components and passive components. Active components are electronic components capable of some dynamic function, such as amplification, oscillation, or signal control, which usually requires a power source for its operation. Examples are bipolar transistors, field-effect transistors, and integrated circuits. Passive components are electronic components that are static in operation, i.e., are ordinarily incapable of amplification or oscillation, and usually require no power for their characteristic operation. Examples are conventional resistors, capacitors, inductors, diodes, rectifiers and fuses.

Electronic components contemplated herein may also be classified as conductors, semiconductors, or insulators. Here, conductors are components that allow charge carriers (such as electrons) to move with ease among atoms as in an electric current. Examples of conductor components are circuit traces and vias comprising metals. Insulators are components where the function is substantially related to the ability of a material to be extremely resistant to conduction of current, such as a material employed to electrically separate other components, while semiconductors are components having a function that is substantially related to the ability of a material to conduct current with a natural resistivity between conductors and insulators. Examples of semiconductor components are transistors, diodes, some lasers, rectifiers, thyristors and photosensors.

Electronic components contemplated herein may also be classified as power sources or power consumers. Power source components are typically used to power other components, and include batteries, capacitors, coils, and fuel cells. As used herein, the term “battery” means a device that produces usable amounts of electrical power through chemical reactions. Similarly, rechargeable or secondary batteries are devices that store usable amounts of electrical energy through chemical reactions. Power consuming components include resistors, transistors, ICs, sensors, and the like.

Still further, electronic components contemplated herein may also be classified as discreet or integrated. Discreet components are devices that offer one particular electrical property concentrated at one place in a circuit. Examples are resistors, capacitors, diodes, and transistors. Integrated components are combinations of components that that can provide multiple electrical properties at one place in a circuit. Examples are ICs, i.e., integrated circuits in which multiple components and connecting traces are combined to perform multiple or complex functions such as logic.

### EXAMPLES

### Example 1

### Experimental Simulations of Copper Diffusion Through Typical Materials

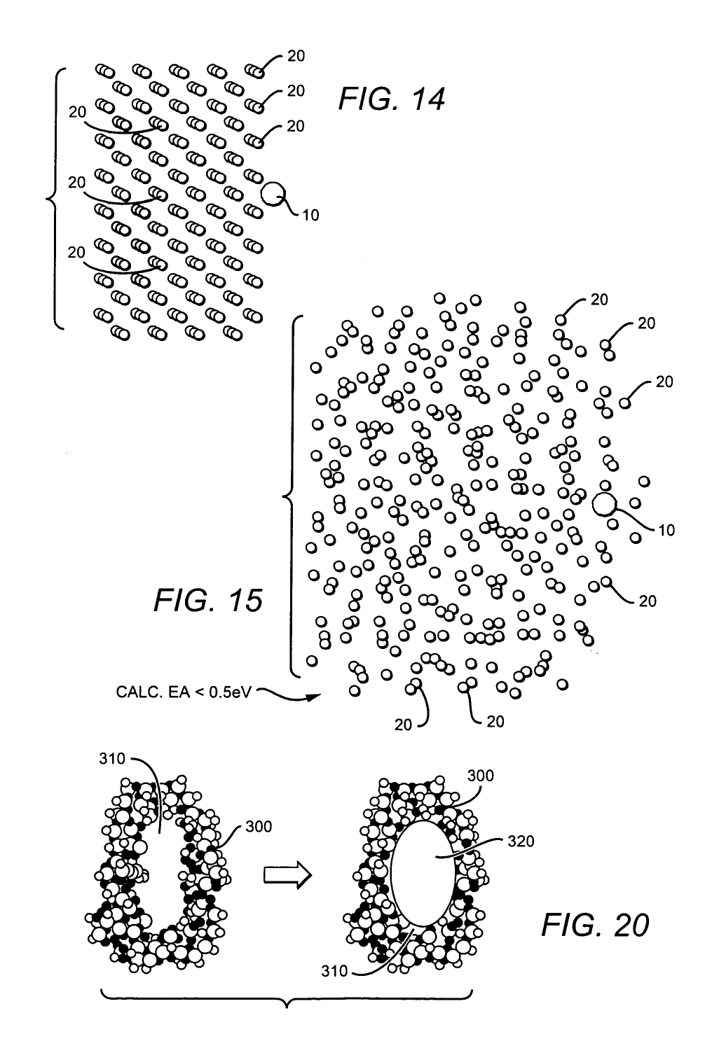

FIGS. 14-15 show an experimental simulation of a copper atom 10 being introduced to and diffusing through a plurality of silicon atoms 20. FIG. 14 shows the plurality of ordered silicon atoms 20 before diffusion of the copper atom 10 into the plurality of silicon atoms 20. FIG. 15 shows the plurality of silicon atoms 20 once diffusion of the copper atom 10 has begun and disorder in the plurality of silicon atoms 20 is induced. The calculated Eₐ is less than 0.5 eV in agreement with literature values (0.43 eV—p. 12-101 CRC Handbook of Chemistry and Physics 77^{th} Edition 1996-1997, David R. Lide, Ed *, CRC Press)

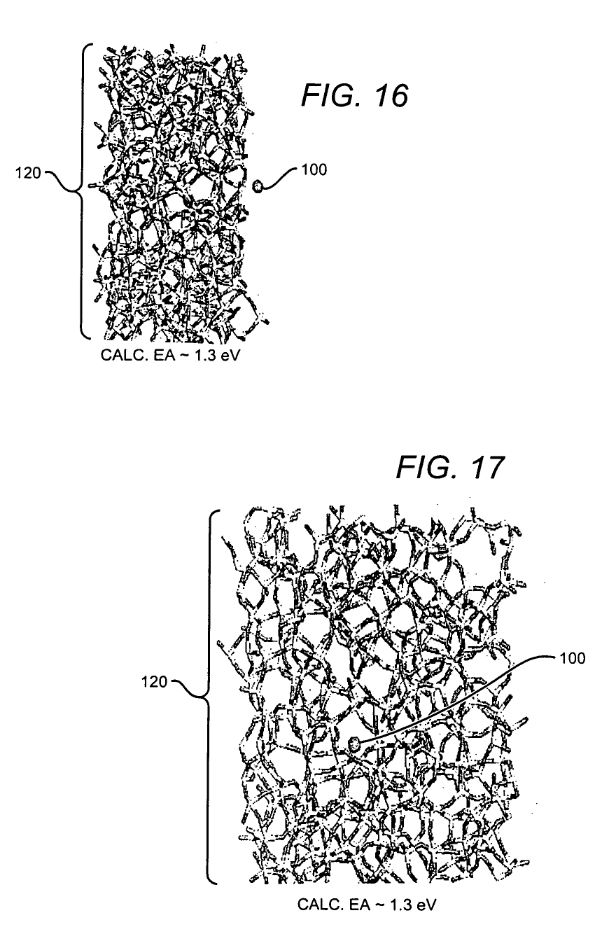

FIGS. 16-17 show an experimental simulation of a copper atom 100 being introduced and diffusing through a silica matrix 120. FIG. 16 shows the diffusion of the copper atom 100 from the side view, wherein the copper atom 100 is approaching the silica matrix 120. FIG. 17 shows the top down view of the diffusion of the copper atom 100 into the silica matrix 120, wherein the copper atom 100 is already diffusing through the silica matrix 120. The calculated Eₐ is about 1.3 eV.

FIG. 18 shows an experimental simulation of a porous organic material matrix 200 having a plurality of pores 210, wherein the porous organic material matrix 200 is coupled to a substrate 220. The flexibility of the matrix and the interfacial responses of the matrix, i.e. the material design, will be very important when trying to control or eliminate copper diffusion through the porous organic material matrix 200. The calculated Eₐ in a worst case scenario is about 0.3 eV.

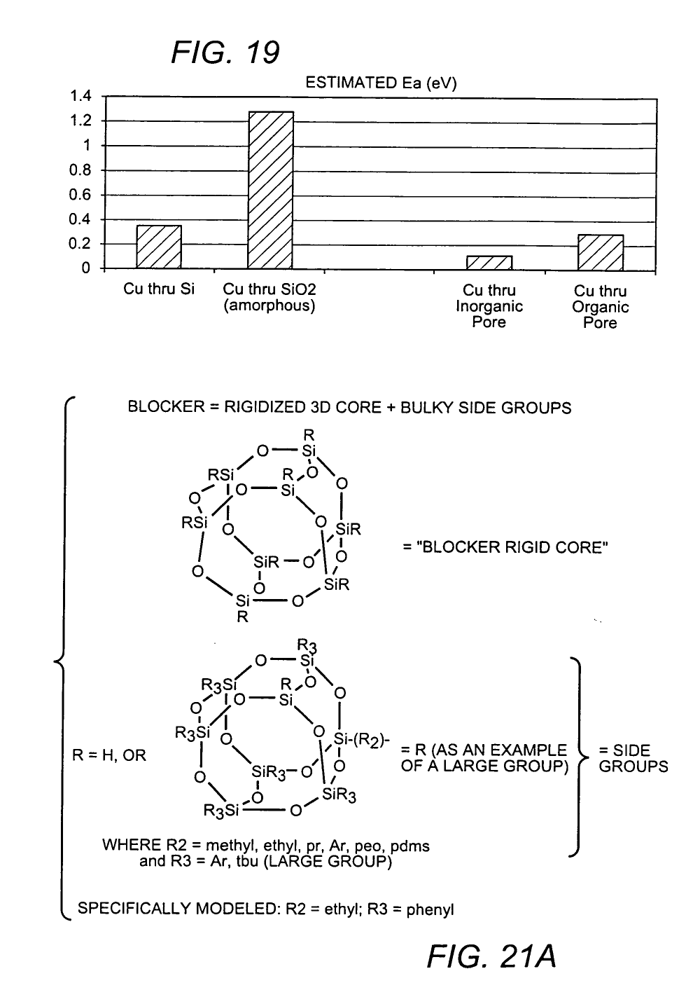

FIG. 19 shows the copper diffusion activation energies that have been determined by the above-described experimental simulations. As shown, porous materials and silicon have activation energies less than about 0.4 eV. For copper atom diffusion to be minimized or eliminated, the minimum activation energy must be greater than about 1.3 eV for a diffusion constant (D) that is less than 1×10⁻¹⁴ cm2/sec at 700K. FIG. 20 shows a molecular simulation of a porous material 300 having a pore 310. It is contemplated herein that a blocking molecule 320 can be introduced to the porous material 300, in order to block the pore 310 and control diffusion of diffusible atoms and/or molecules, such as copper atoms. Established blocking requirements suggest that in order to maximize the blocking ability of a blocking molecule, the molecule a) does not diffuse through the pores by itself (greater than about 1.7 eV estimated from modeling experiments); and b) has a high activation energy toward copper diffusion (greater than about 1.3 eV estimated from modeling experiments).

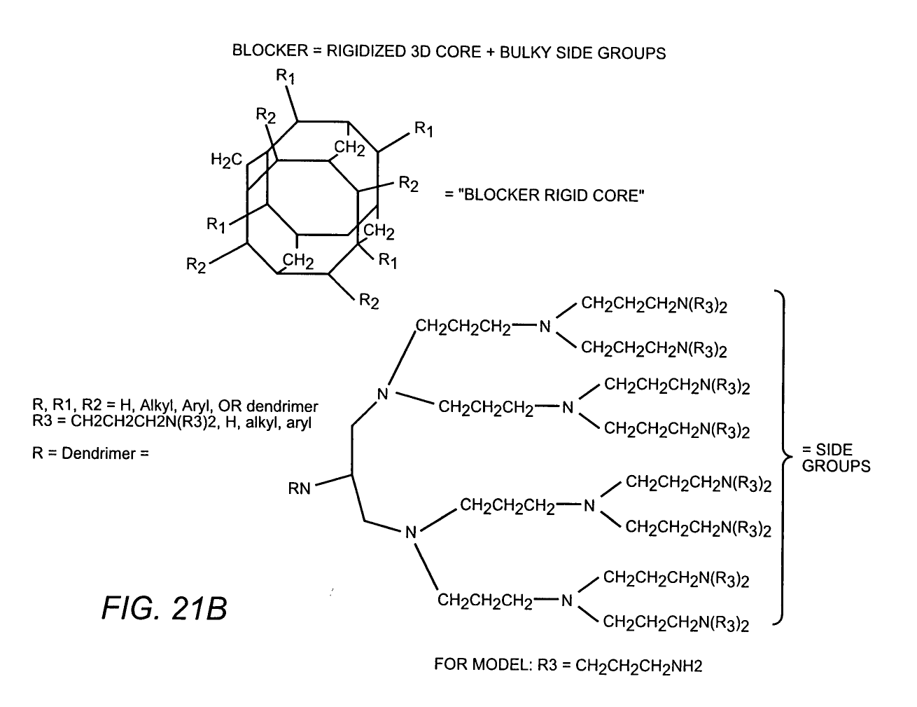

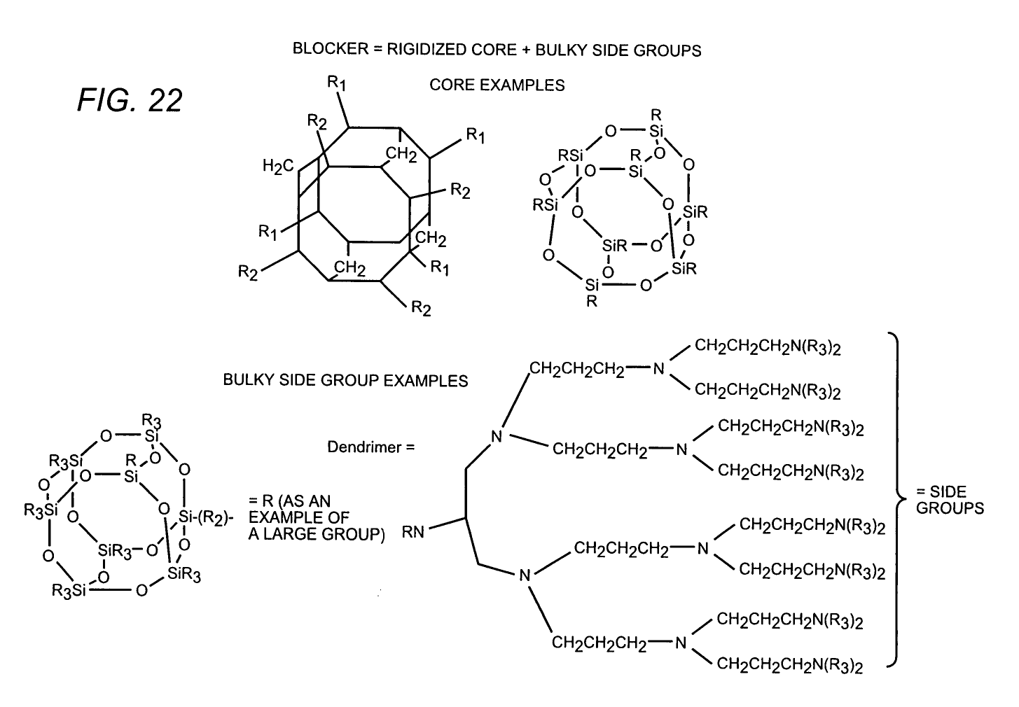

FIGS. 21A, 21B and 22 show examples of blocking agents studied. Simulation experiments of copper through blocking agents suggest that these structures have activation energies toward copper diffusion in excess of 3 eV. Compounds like this have adequate density and rigidity to block copper migration.

### Example 2

### Diffusion Experiments of the Blocking Agent

In this set of experiments, several types of blockers were utilized and two basic types of pores were investigated. The blockers were comprised of two basic architectural features, using a rigid core structure covered with a desired functionality. Blocker molecule “A”, shown in FIG. 21A, comprises an organosiliane based cage blocker molecule (inorganic) in which the surface functionality and the inner rigid core functionality are comprised of an organosilane; and blocker molecule “B”, shown in FIG. 21B, comprises a dendrimer amine-based blocker molecule (organic) surface structure attached to a rigid organic core structure. The important architectural unit of these blocking molecules are the rigid cores, which provides the underlying rigidizing skeletal framework for any attached functionality. By providing a mechanically rigid core, the blocking characteristics are enhanced as the blocking molecule will not deform to allow itself or other molecules to pass easily. The functionality attached to the rigid core is chosen to maximize organic density and/or for other further chemical (ionic or covalent) reactivity or non-bond interaction. As will be discussed later, the functionalities of the outer groups may be changed in accordance to the energy requirements and the size requirements of the pore and/or in accordance with blocking smaller molecule diffusion. The blocking molecule shown in FIG. 22 comprises a mixed organosilane and organic structure. These blocker molecules have adequate activation energies toward copper atom diffusion through each of them. As mentioned, two basic types of pores were investigated also: an inorganic silica pore (represented by generic silica) and organic pores (represented by GX3™, manufactured by Honeywell International, Inc.). A relevant conversion factor is 23.1 kcal/eV.

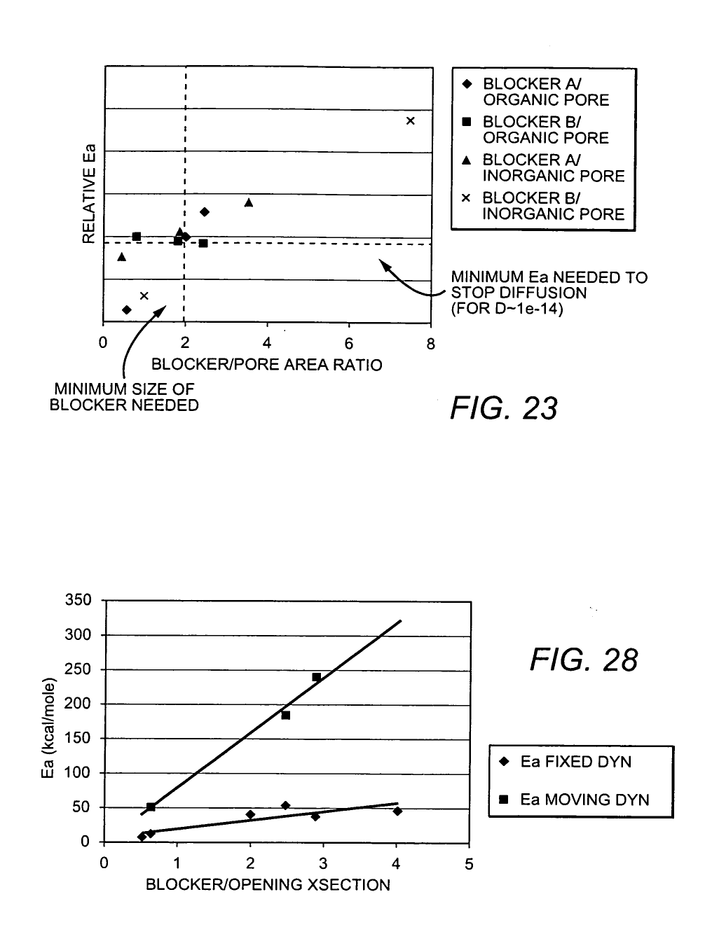

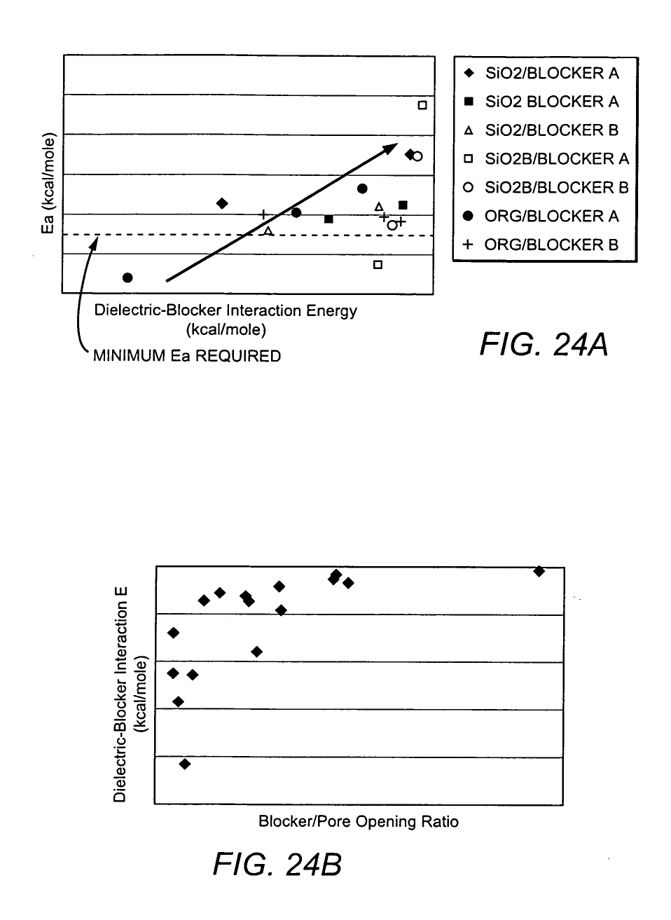

FIG. 23 shows graphically that for inorganic and organic blockers on both inorganic and organic pores, the activation energies for diffusion of the blockers themselves increase with blocker size. FIG. 23 indicates that the molecules can be designed to meet geometry and energy needs. FIG. 24 shows two graphs (A) and (B), wherein graph A shows dielectric-blocker interaction energy (kcal/mol) versus activation energy (kcal/mol), and graph B shows blocker/pore opening ratio versus dielectric-blocker interaction energy (kcal/mol). Generally, a lower interaction between the blocker and the pore (or substrate surface) is necessary to increase the activation energy.

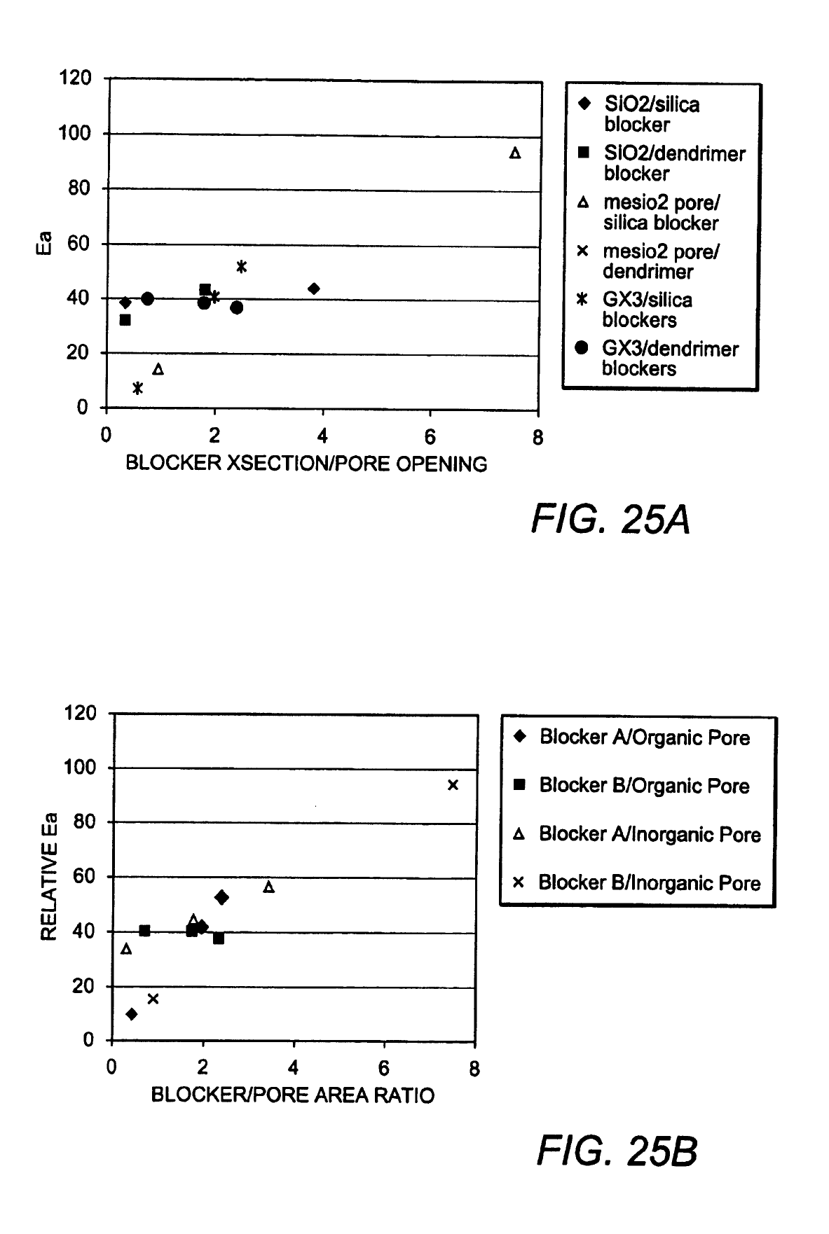

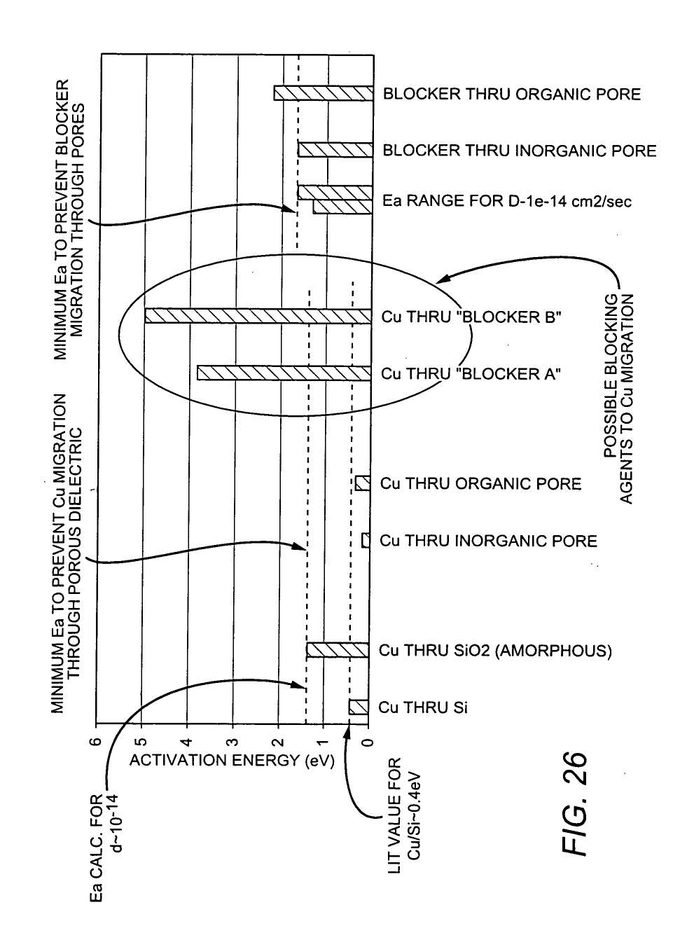

FIG. 25 shows two graphs (A) and (B), wherein graph A shows the blocker cross section/pore opening versus the activation energy, and graph B shows the blocker/pore area ratio versus relative activation energy. It should be noted that the activation energy needed for a diffusion constant of less than about 1×10⁻¹⁴ is about 40 kcal/mol. From these graphs, it can be seen that, in general, the better the binding, the worse the activation energy. The most stable trend is the GX3™/organic dendrimer and SiO₂/silica blocker. These results suggest that, in general, interaction is detrimental to the activation energy. These interactions suggest that in the absence of matrix effects, surface diffusion through the pores is a factor, which is energy interaction driven, rather than matrix driven, where a low surface energy pore helps to prevent diffusion, by having little or no energy driving force which aids diffusion thru the pore. FIG. 26 shows the activation energy summaries from the above-described experimental simulations.

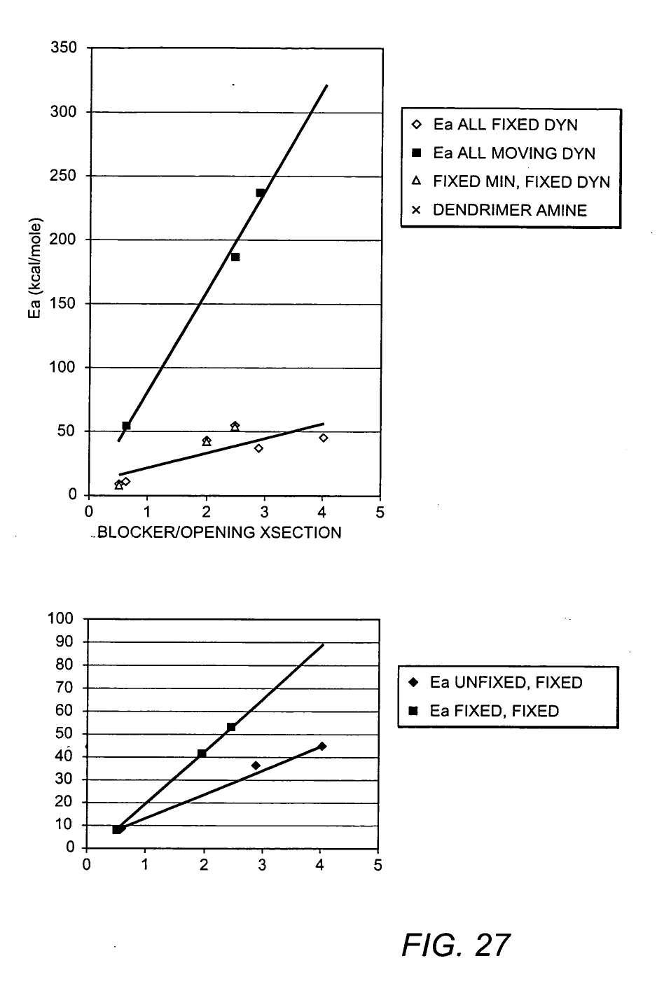

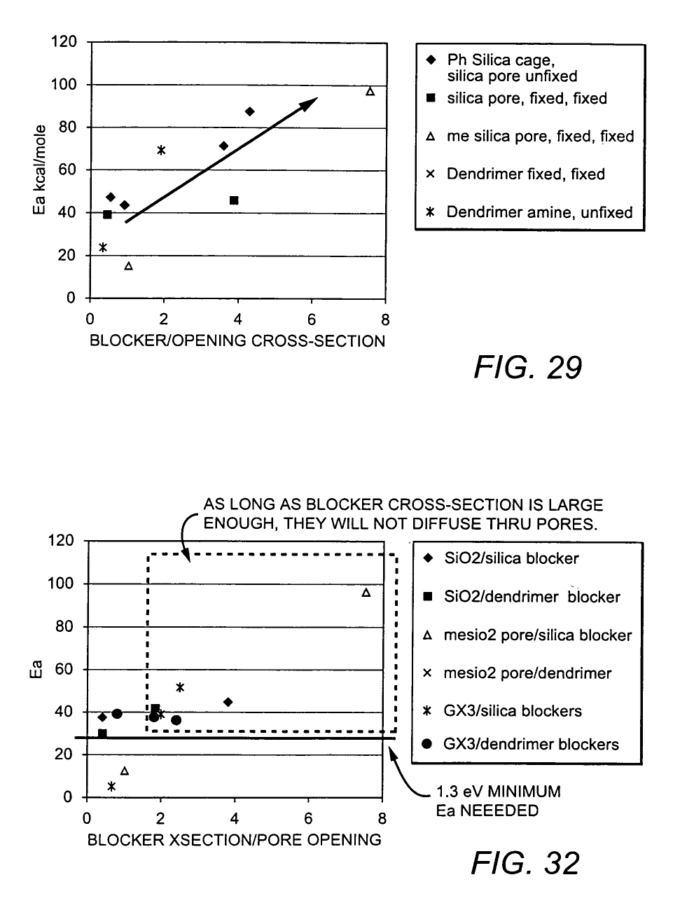

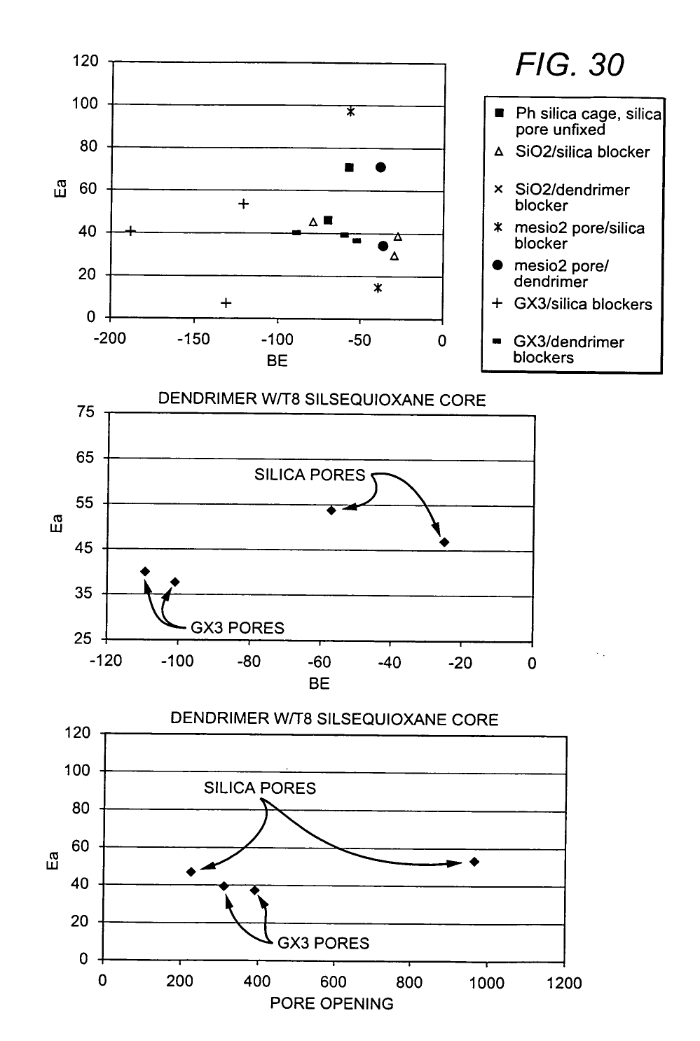

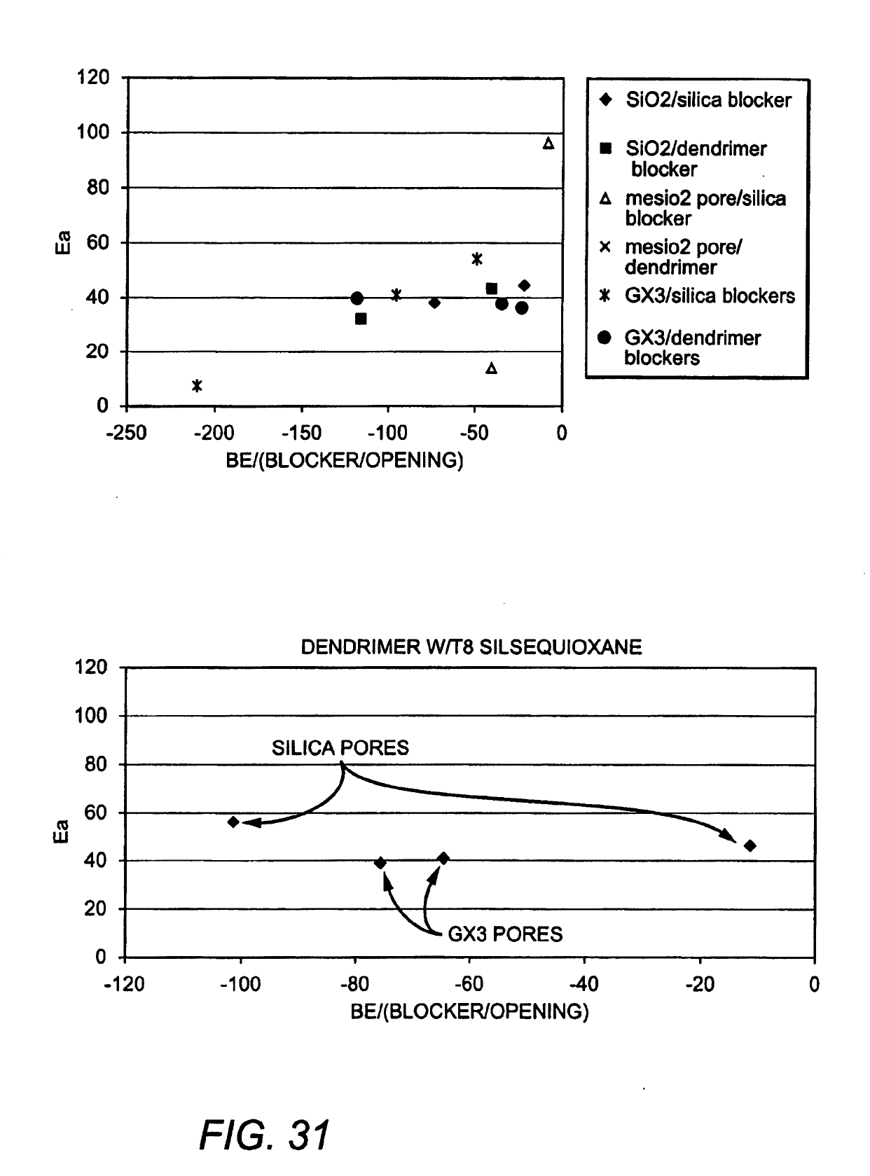

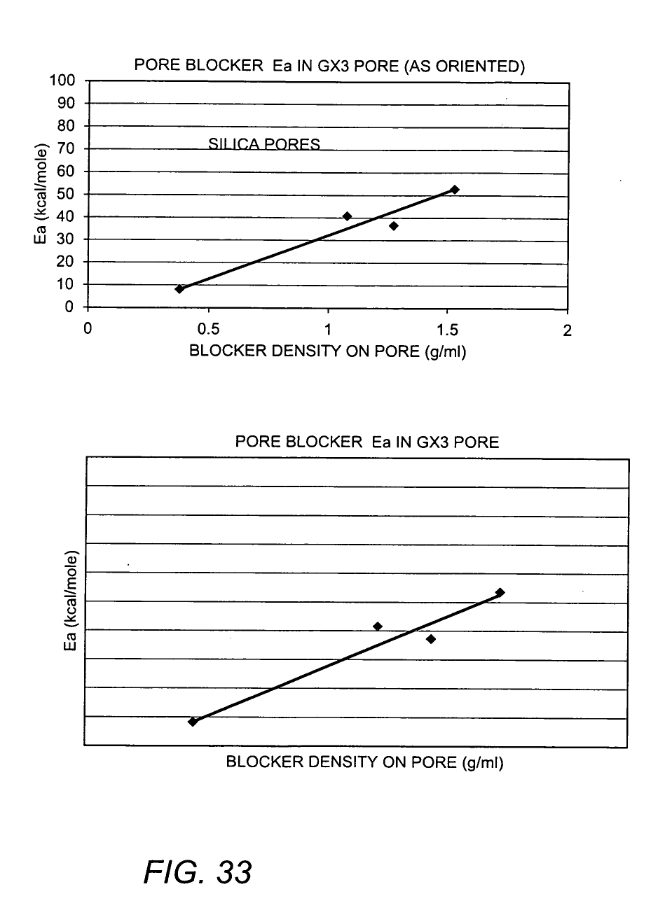

FIG. 27 shows two graphs (A) and (B) that indicate the differences between a rigid pore (fixed) and a flexible pore (moving or “unfixed”). From these graphs, it is understood that a) the response to diffusion involves a matrix “response”; and b) for GX3™, a flexible matrix helps to stop diffusion of the blocker in conjunction with low interaction (binding energy or BE). FIG. 28 confirms the information shown in FIG. 27 by indicating that when a GX3™ pore is used with silica blockers only, the worst case is predicted by assuming a rigid pore. Therefore, when the matrix is generally rigid with no pendant highly branched structures, the likelihood of diffusion increases. According to the models, as compared to silica-based matrices, for organic matrices, this is rigidity link to diffusion is due to the lower density of the organic matrix. FIG. 29 also confirms that for silicon-based pores, the matrix effect difference is less pronounced—meaning that either matrix type (rigid/fixed and flexible/unfixed) should work with both a dendrimer blocker and a silica cage blocker, as long as the blocker/opening cross-section ratio is large enough. That is, in general a matrix effect is noted that is directly related to the dielectric matrix structure and response to force (thermal, mechanical or otherwise), and is indirectly related to the “effective viscosity” described earlier which suggests that the higher the effective viscosity, the lower the diffusion tendency and the higher the activation energy toward diffusion. The effective viscosity is reflected in the rigidity of the matrix as well as its' density. The dielectric density and interfacial density has been previously discussed in terms of copper migration and can be applied here also for other molecules. FIGS. 30-34 show additional experiments and embodiments of the above-described blocker/pore simulations that continue to confirm the results discussed herein. The simulation experiments indicate that in general a lower interaction energy (binding energy BE) between the blocking material and the pore of the dielectric, decreases it's tendency to diffuse through an open pore by increasing the activation energy required for diffusion.

From these descriptions it is obvious that in this case where the diffusing species (for example a pore blocker) is large enough compared the dielectric pore, an interaction between the diffusing species size, the pore size, the attractive forces to the pore and the matrix stiffness exists in which the pore will flex and contract in response to the attraction to the diffusing species. At equilibrium it is expected that the pore is effectively sealed to the diffusion species, as well as to other species, giving a high enough density is established. This is an example where the pore size is small enough in relationship to the diffusing species, where the matrix is flexible, and where there is high enough attraction between the matrix and the diffusing species to contract the pore around the diffusing species. If the size of the diffusing species is too small but pore interaction is high (high pore surface energy), diffusion will not be blocked. As in the example of silica pores, if the matrix cannot contract in response to the diffusing species, then this interaction cannot be used to seal the pore. In this case, and physical size of the pore must be small compared to the diffusing species, along with low pore surface energies. However as previously discussed in the detailed description, if the matrix cannot respond to seal the pore in response to the presence of the pore blocker, the pore blocker material can be used to expand into the pore where either size or reaction of the pore blocking material may seal the pore. Both pore size and low interaction energy with the diffusing species will work together discourage entry and diffusion. These same relationships also exist for the smaller diffusant/blocker molecule.

Returning to the description of the blocker molecule, the architecture or structure of the molecule becomes apparent. Just as the dielectric matrix must have a response to the diffusing species in order to increase it's “effective viscosity” (by containing movement of the matrix through interaction of the pore with the diffusant), the blocker has the same constraints to the architecture.

Besides the need for the blocker to be larger than the pore, to contain movement internal to the blocker structure, an embodiment will consist of a highly rigid core surrounded by a highly branched (dendrimer) surface. The dendrimer may be chosen such that the size of the pore blocker is sufficiently large enough to prohibit it's diffusion into any pore found on the substrate. The rigidity size of the core is chosen large enough to contain movement of the highly branched surface, as well as to be highly dense itself. In addition the surface is branched enough to contain movement of the surface and to increase the overall atom density of the blocker surface. Preferably surface groups will also contain functionality that decreases the interaction with the pore, to further limit diffusion of the blocking molecule itself. However in other embodiments, the surface of the blocker may contain other functionalities in order to provide reactivity or reactivtiy catalysis with the underlayer, polymerization of the blocker, or carry precursors for other processes such as CVD/ALD.

### Example 3

### Process Applications

As mentioned earlier, FIGS. 21A, 21B and 22 show examples of blocking structures, which can be used as described as passive blocking agents, or can be further functionalized for other processes important to the electronic materials industry.

For example, the surface of the blocker structure may consist of an active chemical etchant or cleaner, such as a fluoride-based silica etchant or an amine-based hydroxy cleaning agent. For instance the termination functionality of the surface may contain an ion pair of an ammonium fluoride, ammonium hydroxide as the active etchant or cleaner. The terminating functionality of the surface may contain a photosensitive superacid, which serves as the etchant or cleaner upon irradiation. The superacid may also provide catalytic conditions for further breakdown of the underlayer. The blocking nature of the size and shape of the molecule limits penetration of the blocking molecule into the dielectric material, but has reactive functionality to etch or clean only the immediate surface providing a controlled etching or controlled cleaning molecule.

In another contemplated embodiment, the surface functionality of the blocking molecule can also contain a complexed copper or metal that can be further reduced or directly serve as a seed layer for metal deposition. Such a complex may contain ligands such as in the porphyrin family (phthalocyanines); the cyanine family; the multiolefin family; the cyclo-olefin family such as the pyroles, thiophenes or furans; the cyclopentadienide family; heteroatom aromatic family such as pyridyl; or the acetylide family, or in the spirit of molecules that may orient, chain align and densify, the diffusion blocking material may be of a conductive polymer class such as but not limited to a polythiophene moiety, a polyacetylene moiety, a polypyrrole moiety, a polypyridine moiety, a polyaniline moiety or a combination thereof. The latter conductive polymers may be alternately serve as seed layers if the conductivity is high.

In yet another contemplated embodiment, the surface functionality can contain a crosslinkable group (thermal, chemical or photochemical), which serves to densify the immediate surface of the dielectric. Crosslinkable functionalities may be olefins or multiolefins, cyclo-olefins, acrylate, methacrylates, cyano-acrylates, cyanates, epoxies, acetylides, silanes, alkoxy organosilanes, acetoxy organosilanes, cyanoacrylates, isocyanates, isocyanurates, α,β unsaturated aldehydes or ketones, α,β unsaturated esters, α,β unsaturated amides, α,β unsaturated imides. In addition the crosslinkable functionality may be comprised of a reactant designed to specifically react to a substrate surface functionality. Examples of reactant combinations include an alcohol or amine for a surface epoxy or isocyanate; an ester or anhydride for a surface alcohol, amine or epoxy; an epoxy or isocyanate for a surface alcohol or amine etc. In this way, the dielectric constant of the bulk of the dielectric layer is not compromised, but a permanent, more mechanically resistant barrier that is covalently bonded results. This permanent barrier can be used before other processes such as etching (dry/wet), cleaning, CVD application or CMP (chemical mechanical polishing) procedure in order to provide enhanced resistance of a surface to the process. For example in CMP, the barrier provides more resistance to solvent penetration that degrades mechanical performance and survivability to the process.

In a similar role as containing a crosslinkable group, the terminating functionality of the surface may contain a photosensitive catalyst such as a free radical or superacid generator, which serves as a crosslink catalyst for the immediate surface of the dielectric or the immediate interface of the blocker molecule/dielectric or serve as the catalyst for curing of the next process layer. Such catalysts include the onium salts (for example, diaryl iodonium salts e.g. diphenyliodonium, triaryl sulfonium salts, phenacylsulfonium salts, ferrocenium salts, triphenylpyrylium dialkylphenacylsulfonium salts etc.), peroxides and peracids.

In another contemplated embodiment, the surface functionality is adjusted to be chemically compatible with the subsequent layer in a process. The blocker molecule can be used to enhance adhesion of a dielectric, photoresist, BARC layer or metal layer depending upon when it is applied in the IC process. Enhanced adhesion may be obtained by functionalizing the surface with groups that are attracted to or react with the next contact layer. The blocker molecule can also be used to enhance wetting (a surface wetting agent) of a subsequent layer, without disruption of the underlayer. Surface wetting enhancement may be done using attachment of surfactant functionalities. Typical functionalities used in surfactants include long chain fatty acids, polyoxyethylenes, polyoxypropylenes, carbohydrates and long chain organic acids or sulfonic acids.

The blocker can also be used to enhance CVD/ALD deposition at the specific blocker site, depending upon the CVD/ALD precursor. For instance if the surface functionality of the blocker molecule has better binding ligands to a metal CVDALD precursor, preferential deposition should occur at these sites without worry of further penetration of the CVD/ALD precursor to the interior of the underlayer. If the blocker molecule surface functionality consists of ligand molecules specific to copper or other metals, it may be preferentially deposited on those surfaces as a barrier layer or a precursor layer. Such ligands include: the porphyrin family (phthalocyanines), the cyanine family, the multiolefin family, the cyclo-olefin family, the cyclopentadienide family, the heteroatom aromatic family, or the acetylide family or a conductive polymer class such as but not limited to a polythiophene moiety, a polyacetylene moiety, a polypyrrole moiety, a polypyridine moiety, a polyaniline moiety or a combination thereof.

In still another contemplated embodiment, the functionality attached to the blocking molecule can be adjusted to allow differential diffusion of the molecule in order to carry specific species into the interior of a structure. The differential diffusion may be controlled by either control of the blocking molecule size or attachment of long side single strand chains from which the activity is defined by the chain functionality or at the end of the chains. This allows partial penetration of other species such as metal precursors, which can be subsequently reacted to metals, metal oxides and mixed inorganic compounds or intermetallics. If the buried precursors are reacted to metals, the new composite material can serve as a resistor structure, which is fabricated without additional photolithography, and where subsequent metallization of the surface will provide the electrodes. For example buried tungsten may be deposited by precursors similar to art developed by L. McElwee et.al (J of Crystal Growth 249 (2003) 262-274) by use of a long chain amide linked directly to a blocker core. So for example, in FIG. 22, the one or all of R groups attached to the rigid core structure may be composed of C14W[N—CH(CH₃)₂][N—(CH2)]ₙ—. Decomposition of the this precursor leads to reduced tungsten metal, but penetration depth into the substrate is determined by the length of the CH2 chain. Using the same rationale, if the buried precursors are inorganic oxides or inorganic composites, capacitors can be fabricated from the initial dielectric structure. If the buried precursors are ferroelectric inorganics, a ferroelectric switch structure can be fabricated. If the buried precursors are CVD graphite/diamond catalysts, an enhanced thermal layer can be fabricated.

A differential dielectric constant may be fabricated in the underlying dielectric layer by attachment of long chain reactant species to the blocking molecule. The amount of dielectric constant change will be defined by the length of the long chain species and the functionality attached. The buried reactant, such as a catalyst, a superacid, an amine salt or a solvating or co-solvating functional group. For example one or all of the R groups attached to the central rigid core in FIG. 22 may be replaced by species such as (CH₂)ₙSO₃H for an example of a superacid; or (CH₂)ₙArI⁺Ar MXₙ⁻ (where MXₙ⁻ is a general complex ion such as SbF₆⁻, SO₄⁻ etc.) as an example of a photoinitiator; ROOR or RNNR as an example of a free radical initiator; or (CH2)ₙNH₄F as an example of a fluoride etch. For the latter example, both the solvent and other R group choices will determine the extent of ionization of the ion pair and thus “free” fluoride. Thus equilibrium constants and reactivity of the free ion with silion or silicon-containing substrates may be adjusted, where more organic content is expected to increase the tight ion pair. The (CH₂)ₙ long chain may be replaced by any other linear molecular structure. The superacid or the catalyst may function to either further crosslink (increase dielectric constant and increase etch resistance) or catalytically degrade (decrease dielectric constant) the underlayer. The amine salt may serve to degrade the immediate surrounding to the long chain functionality. The solvating or co-solvating functional group such as polyethylene oxide, polypropylene oxide, polylactic acid, polyethylactate, polyvinylsulfonic acid, may serve to co-solvate interior material when processed with a final clean step, or may serve to initiate and enhance etch rate (decrease etch resistance).

### Example 4

### Carbon-Including Diffusion Barrier Layer Modeling Studies

Modeling techniques such as those disclosed herein and also described in Issued U.S. Pat. No. 6,544,650, which is commonly owned and incorporated herein in its entirety, are used to model a carbon-including diffusion barrier layer, such as a carbon graphite barrier layer. However, in an extension to this concept single carbon nanotubes grown as interconnects may be also be considered self-diffusion barrier layers due to the high dense graphitic nature of the carbon walls either in a pure graphitic form or in a diamond-like construction. Integrated, predictive ab initio and informatics tools can also be: extended to CVD-fabrication areas such as thermal conduction layers, and ferroelectric, thermoelectric, and semiconductor materials. This material development scheme may generically termed Integration of Modeling, Informatics for Materials Fabrication (IMIMF).

In order to address the specific chemistry of carbon nanotubes (“CNT”) catalysis and growth, which provides insight on fabrication, an ab initio method can be developed which will take into account the surrounding reaction environment (catalyst surface, reactants and conditions) for chemical vapor deposition (CVD).

For this method, a hybrid Quantum Mechanics-Molecular Mechanics approach can be used, which is unique in guiding a robust reaction environment. In addition an informatics tool which extends across multiple scales (atomistic to macromolecular) can be developed to derive a statistical, predictive model of target end-use structures. The basic underlying software technology is capable of defining key variable spaces, visualizing complex data relationships, and correlating target properties with materials to permit data-base queries from a broad spectrum of data mining engines and the development of property-structure relationships. The integration of all the modeling tools through the use of informatics bridges catalytic CNT fabrication using chemical vapor deposition (CVD) techniques with their end-use applications. The resulting methods and knowledge can be applied in the design, fabrication and characterization of CNT-based sensors or other MEMS devices.

However the basic concept is the same: use Quantum Mechanic-Molecular Mechanics (QM-MM) hybrids with extended solvation character to model the reaction species and the reaction conditions; use specific quantum mechanics to derive force fields for the molecular mechanics part of the QM-MM hybrid; use these models to explain basic thermodynamics for reactions; scale using process models; use quantum mechanics predict basic electronic structure-property correlations; use molecular mechanics and dynamics to further predict mechanical structure-property correlations; use all model trends in a multivariate analysis of property to structure to fabrication condition prediction.

In this way, everything from the correct structure for the desired property and the fabrication conditions are modeled and the direction of fabrication and which structure to target are predicted.

### Example 5

### Carbon-Including Diffusion Barrier Layer Studies

Example 4 shows modeling techniques and methods that can be utilized to determine if a carbon-including diffusion barrier layer is useful in electronic and semiconductor applications. Those modeling studies are confirmed by experimental data shown herein.

The densified carbon-including layer showed excellent barrier strength against Cu diffusion (FIG. 35). FIG. 36 shows Cu diffusion through NANOGLASS and HOSP in the absence of a densified carbon-including diffusion barrier layer, such as those described herein. It is known that carbon does not diffuse through copper and has exceedingly small solubility in copper. The modeling experiments shown in Example 4 showed that the potential field between copper and carbon is not favorable for copper diffusion. This information prompted an investigation into the barrier strength of carbon-including film against copper diffusion. 100 and 200 A thick hydrogenated (20-30%) amorphous carbon films were deposited on NANOGLASS by employing plasma enhanced CVD method with SAMCO's proprietary chemical mixture, followed by 1200 A copper seed deposition at room temperature. The film stacks were annealed in an ENDURA® (available from Applied Materials) for one hour at 400 C. SEM examination showed that there was no apparent diffusion through carbon film.

As suggested by FIG. 5, in which the density of the interfacial composition is most likely greater than 1.5 g/cc, this experiment shows that a dense layer of a material such as graphite (which have reported densities [CRC Handbook 77^{th} edition, David Lide editor, 996 CRC Press p. 4-7] ranging from 1.8 to 2.3) can act as a blocking agent to copper migration.

Thus, specific embodiments, methods of formation and applications of layered materials and components have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A layered component comprising:
a substrate;
a dielectric material having a plurality of pores, wherein the material is coupled to the substrate; and
a self-assembled diffusion blocking material coupled to the dielectric material, wherein the diffusion blocking material is attracted to the dielectric material.

2. The layered component of claim 1, wherein the substrate comprises a plurality of layers.

3. The layered component of claim 1, wherein the plurality of layers comprises at least one silicon wafer.

4. The layered component of claim 1, wherein the dielectric material comprises at least one organic compound.

5. The layered component of claim 4, wherein the at least one organic compound comprises at least one cage compound.

6. The layered component of claim 5, wherein the at least one cage compound comprises adamantane.

7. The layered component of claim 1, wherein the dielectric material comprises a low k dielectric material.

8. The layered component of claim 1, wherein the dielectric material comprises at least one inorganic compound.

9. The layered component of claim 1, wherein the diffusion blocking material comprises a dense carbon-including material or dense inorganic material.

10. The layered component of claim 1, wherein the diffusion blocking material comprises a dense rigid core surrounded by a dense, more flexible matrix.

11. The layered component of claim 10, wherein the diffusion blocking material is larger than the pore by an average cross-sectional area ratio greater than 1.5:1.

12. The layered component of claim 10, wherein the diffusion blocking material is larger than the pore by an average cross-sectional area ratio greater than 2:1.

13. The layered component of claim 1, wherein a plurality of diffusion blocking materials forms a diffusion blocking layer.

14. The layered component of claim 10, wherein the flexible matrix comprises a capping moiety.

15. The layered component of claim 14, wherein the flexible matrix further comprises at least one long chain unit.

16. The layered component of claim 15, wherein the at least one long chain unit comprises at least three single bonds.

17. The layered component of claim 14, wherein at least one long chain unit comprises an alkane moiety, a long chain ketone moiety, a long chain ester moiety, a long chain alcohol moiety, a long chain amine moiety, a long chain thiol moiety, polyoxyethylene moiety, a polyoxymethylene moiety, a polyalkene moiety, a polyglycol moiety, a polyaromatic ether moiety, a polydimethylsiloxane moiety, a polydialkylsiloxane moiety, a polyalkylarylsiloxane moiety or a combination thereof.

18. The layered component of claim 14, wherein the capping moiety comprises at least one acidic species or at least one long chain unit capped with an acidic species.

19. The layered component of claim 18, wherein the acidic species comprises a superacid, an organic acid or combinations thereof.

20. The layered component of claim 18, wherein the capping moiety comprises a metal ligand compound, a CVD or ALD precursor or a combination thereof.

21. The layered component of claim 18, wherein the capping moiety comprises at least one salt.

22. The layered component of claim 21, wherein the at least one salt comprises an ammonium fluoride salt, an ammonium hydroxide salt or a combination thereof.

23. The layered component of claim 18, wherein the capping moiety comprises a photoinitiator, a free radical initiator or a combination thereof.

24. The layered component of claim 18, wherein the capping moiety comprises a basic species.

25. The layered component of claim 24, wherein the basic species comprises a metal hydride, a metal hydroxide or a combination thereof.

26. The layered component of claim 18, wherein the capping moiety comprises a crosslinkable functionality or at least one long chain units capped with a crosslinkable functionality.

27. The layered component of claim 10, wherein the rigid core comprises a silsesquioxane, a siloxane polymer, a multicyclic siloxane, a multicyclic inorganic compound or a combination thereof.

28. The layered component of claim 10, wherein the rigid core comprises an aromatic compound.

29. The layered component of claim 28, wherein the aromatic compound comprises a porphyrin moiety, an annulene moiety, a fullerene moiety, a metallocene moiety or a combination thereof.

30. The layered component of claim 10 wherein the rigid core comprises a bridged multicyclic compound.

31. The layered component of claim 10, wherein the rigid core comprises at least one multicyclic aliphatic bond.

32. The layered component of claim 31, wherein the multicyclic aliphatic bond comprises a cubene or a paracyclophane.

33. The layered component of claim 9, wherein the density of the carbon-including material is >1.5 g/cc at the interface.

34. The layered component of claim 9, wherein the diffusion blocking material comprises at least one flat aromatic molecule oriented flat to the substrate.

35. The layered component of claim 9, wherein the dense carbon-including material comprises at least one of graphite, diamond, a porphyrin layer, cyanine layer, a polyporphryin layer, a conductive polymer or a combination thereof.

36. The layered material of claim 1, wherein the diffusion blocking material comprises at least one metal-ligand compound or a CVD or ALD precursor material.

37. The layered material of claim 1, wherein the diffusion blocking material comprises at least one ligand.

38. The layered material of claim 37, wherein the at least one ligand is coupled to a metal atom.

39. The layered material of claim 37, wherein the ligand comprises a cyanine group, a porphyrin group, an acetylide group, a cyclopentadienyl group, a cyclo-olefinic group a multiolefinic group, a conductive polymer or a combination thereof.

40. The layered material of claim 38, wherein the metal atom is copper, iron, cobalt, titanium, tantalum, silver, magnesium, aluminum, gold, zinc, tungsten or chromium.

41. The layered material of claim 38, further comprising a removable metal cap layer.

42. The layered material of claim 1, wherein the diffusion blocking material forms a continuous layer.

43. The layered material of claim 42, wherein the continuous layer decreases a diffusion of metal atoms, reactive etchants or a CVD or ALD precursor material into the dielectric material by at least about 50%.

44. The layered material of claim 43, wherein the continuous layer decreases the diffusion of metal atoms, reactive etchants or a CVD or ALD precursor material into the dielectric material by at least about 75%.

45. A method of minimizing the diffusion of metal atoms, reactive etchants or a CVD or ALD precursor material into a material having a plurality of pores, comprising:
providing a precursor material that comprises a carbon-including material;
providing a solvent carrier solution;
combining the precursor material and the solvent carrier solution to form a diffusion blocking reactive solution; and
applying the diffusion blocking reactive solution to the material having a plurality of pores to form a diffusion blocking material.

46. The method of claim 45, further comprising:
providing at least one ligand-metal couple, a combination of a ligand material and a metal ion solution or a combination thereof; and
applying the at least one ligand-metal couple, the combination of the ligand material, and the metal ion solution or the combination thereof to the material having a plurality of pores.

47. The method of claim 45, wherein the material comprising a plurality of pores is further coupled to a substrate.

48. The method of claim 47, wherein the substrate comprises a plurality of layers

49. The method of claim 48, wherein the plurality of layers comprises at least one silicon wafer.

50. The method of claim 45, wherein the material having a plurality of pores comprises a dielectric material having a dielectric constant less than about 4.

51. The method of claim 50, wherein the dielectric material comprises at least one organic compound.

52. The method of claim 51, wherein the at least one organic compound comprises at least one cage compound.

53. The method of claim 52, wherein the at least one cage compound comprises adamantane.

54. The method of claim 50, wherein the dielectric material comprises at least one inorganic compound.

55. The method of claim 46, wherein the diffusion blocking material comprises at least one metal ligand compound or CVD or ALD precursor material.

56. The method of one of claims 45 or 46, wherein the diffusion blocking material comprises at least one ligand.

57. The method of claim 55, wherein the at least one ligand is coupled to a metal atom.

58. The method of claim 56, wherein the ligand comprises a cyanine group, aporphyrin group, an acetylide group, a cyclopentadienyl group, a cyclo-olefinic group a multiolefinic group, a conductive polymer or a combination thereof.

59. The method of claim 57, wherein the metal atom is copper, iron, cobalt, titanium, tantalum, ruthenium, silver, magnesium, aluminum, gold, zinc, tungsten or chromium.

60. The method of claim 46, further comprising inducing a catalytic reaction between at least one metal-ligand couple, the combination of the ligand material and the metal ion solution or the combination thereof and the diffusion blocking reactive solution to form the diffusion blocking material.

61. The method of claim 45, wherein the diffusion blocking material comprises a capping moiety.

62. The method of claim 61, wherein the capping moiety undergoes a crosslinking reaction with the porous material.

63. The method of claim 61, wherein the capping moiety undergoes a crosslinking reaction with itself or another capping moiety.

64. The method of claim 60, wherein the diffusion blocking material comprises a dense carbon-including material.

65. The method of claim 64, wherein the dense carbon-including material comprises at least one of graphite, diamond or a combination thereof.

66. The method of claim 45, wherein diffusion blocking reactive solution is physically attracted to the dielectric material.

67. The method of claim 60, wherein the diffusion blocking material forms a continuous layer.

68. The method of claim 67, wherein the continuous layer decreases a diffusion of metal atoms into the dielectric material by at least about 50%.

69. The method of claim 68, wherein the continuous layer decreases the diffusion of metal atoms into the dielectric material by at least about 75%.

70. An electronic component comprising the layered material of claim 1.

71. A semiconductor component comprising the layered material of claim 1.

72. A layered material, comprising:
a porous material comprising a porous surface; and
a layer of blocking material comprising reactive functionalities coupled to the porous surface, wherein the interaction of the reactive functionalities with the porous material forms a diffusion blocking layer.

73. The layered material of claim 72, wherein the blocking material comprises a large dense rigid core surrounded by a dense flexible matrix capped by at least one reactive functionality.

74. The layered material of claim 73, wherein the at least one reactive functionality has a limited chain length for control of penetration into the surface.

75. The layered material of claim 72, wherein the blocking molecule is composed of a rigid core with at least one long chain attached to the rigid core, wherein the long chain is capped by at least one reactive functionality.

76. The layered material of claim 75, wherein the rigid core comprises a dense carbon-based material or a dense inorganic material.

77. The layered material of one of claims 73 or 75, wherein the reactive functionality reacts with the porous material.

78. The layered material of one of claims 73 or 75, wherein the reactive functionality comprises at least one acidic species or at least one long chain unit capped with an acidic species.

79. The layered material of claim 78, wherein the acidic species comprises a superacid, an organic acid or combinations thereof.

80. The layered material of one of claims 73 or 75, wherein the reactive functionality comprises a metal ligand compound, a CVD or ALD precursor or a combination thereof.

81. The layered material of claim 80, wherein the reactive functionality further comprises at least one long chain unit.

82. The layered material of claim 81, wherein the at least one long chain unit comprises at least three single bonds.

83. The layered material of claim 81, wherein the at least one long chain unit comprises an alkane moiety, a long chain ketone moiety, a long chain ester moiety, a long chain alcohol moiety, a long chain amine moiety, a long chain thiol moiety, polyoxyethylene moiety, a polyoxymethylene moiety, a polyalkene moiety, a polyglycol moiety, a polyaromatic ether moiety, a polydimethylsiloxane moiety, a polydialkylsiloxane moiety, a polyalkylarylsiloxane moiety or a combination thereof.

84. The layered material of one of claims 73 or 75, wherein the reactive functionality comprises at least one salt.

85. The layered material of claim 84, wherein the at least one salt comprises an ammonium fluoride salt, an ammonium hydroxide salt or a combination thereof.

86. The layered material of one of claims 73 or 75, wherein the reactive functionality comprises a photoinitiator, a free radical initiator or a combination thereof.

87. The layered material of one of claims 73 or 75, wherein the reactive functionality comprises a basic species.

88. The layered material of claim 87, wherein the basic species comprises a metal hydride, a metal hydroxide or a combination thereof.

89. The layered material of one of claims 73 or 75, wherein the reactive functionality comprises a crosslinkable functionality or at least one long chain units capped with a crosslinkable functionality.

90. The layered material of claim 89, wherein the crosslinkable functionality is crosslinked using a photoinitiator, a free radical initiator, an acid, a base or a combination thereof.

91. The layered material of claim 90, wherein the crosslinkable functionality comprises an epoxy, an olefin, an acetylene, a siloxane, a cycloolefin, an acrylate, a cyanate ester, an isocyanate or combination thereof.

92. The layered material of claim 81, wherein the reactive functionality comprises a salt.

93. The layered material of claim 92, wherein the salt comprises an ammonium salt.

94. The layered material of claim 93, wherein the reaction of the ammonium salt with the porous material produces a solvent soluble species which may be solvated by a solvent.

95. The layered material of claim 81, wherein the reactive functionality comprises a base.

96. The layered material of claim 95, wherein the reaction of the base with the porous material produces a solvent soluble species which may be solvated by a solvent.

97. The layered material of claim 81, wherein the reactive functionality comprises an acidic species.

98. The layered material of claim 97, wherein the reaction of the acidic species with the porous material produces a solvent soluble species which may be solvated by a solvent.

99. The layered material of claim 73, wherein the rigid core comprises a silsesquioxane, a siloxane polymer, a multicyclic siloxane, a multicyclic inorganic compound or a combination thereof.

100. The layered material of claim 73, wherein the rigid core comprises an aromatic compound.

101. The layered material of claim 100, wherein the aromatic compound comprises a porphyrin, an annulene, a fullerene, a metallocene or a combination thereof.

102. The layered material of claim 73, wherein the rigid core comprises at least one multicyclic aliphatic bond.

103. The layered material of claim 102, wherein the multicyclic aliphatic bond comprises a cubenes or a paracyclophane.

104. The layered material of claim 73, wherein the reactive functionality may act as a catalyst for the polymerization of an additional layer of material.

105. A layered component comprising:
a substrate;
a dielectric material having a plurality of pores, wherein the material is coupled to the substrate; and
a self-assembled diffusion blocking material coupled to the dielectric material, wherein the diffusion blocking material reacts with the dielectric material.

106. The layered component of claim 105, wherein the substrate comprises a plurality of layers.

107. The layered component of claim 105, wherein the plurality of layers comprises at least one silicon wafer.

108. The layered component of claim 105, wherein the dielectric material comprises at least one organic compound.

109. The layered component of claim 108, wherein the at least one organic compound comprises at least one cage compound.

110. The layered component of claim 109, wherein the at least one cage compound comprises adamantane.

111. The layered component of claim 105, wherein the dielectric material comprises a low k dielectric material.

112. The layered component of claim 105, wherein the dielectric material comprises at least one inorganic compound.

113. The layered component of claim 105, wherein the diffusion blocking material comprises a dense carbon-including material or dense inorganic material.

114. The layered component of claim 105, wherein the diffusion blocking material comprises a dense rigid core surrounded by a dense, more flexible matrix.

115. The layered component of claim 114, wherein the diffusion blocking material is larger than at least one of the plurality of pores by an average cross-sectional area ratio greater than 1.5:1.

116. The layered component of claim 115, wherein the diffusion blocking material is larger than at least one of the plurality of pores by an average cross-sectional area ratio greater than 2:1.

117. The layered component of claim 114, wherein the flexible matrix comprises a capping moiety.

118. The layered component of claim 117, wherein the flexible matrix further comprises at least one long chain unit.

119. The layered component of claim 118, wherein the at least one long chain unit is terminated with the capping moiety.

120. The layered component of claim 118, wherein the at least one long chain unit comprises at least three single bonds.

121. The layered component of claim 118, wherein the at least one long chain unit comprises an alkane moiety, a long chain ketone moiety, a long chain ester moiety, a long chain alcohol moiety, a long chain amine moiety, a long chain thiol moiety, polyoxyethylene moiety, a polyoxymethylene moiety, a polyalkene moiety, a polyglycol moiety, a polyaromatic ether moiety, a polydimethylsiloxane moiety, a polydialkylsiloxane moiety, a polyalkylarylsiloxane moiety or a combination thereof.

122. The layered component of one of claims 117 or 119, wherein the capping moiety reacts with the dielectric material to seal at least one of the plurality of pores.

123. The layered component of one of claims 117 or 119, wherein the capping moiety comprises nonpolar moieties, wherein the nonpolar moieties lower the surface energy of the dielectric material.

124. The layered component of one of claims 117 and 119, wherein the capping moiety undergoes a crosslinking reaction with the dielectric material.

125. The layered component of claim 117, wherein the capping moiety comprises at least one acidic species or at least one long chain unit capped with an acidic species.

126. The layered component of claim 125, wherein the acidic species comprises a superacid, an organic acid or combinations thereof.

127. The layered component of claim 117, wherein the capping moiety comprises a metal ligand compound, a CVD or ALD precursor or a combination thereof.

128. The layered component of claim 117, wherein the capping moiety comprises at least one salt.

129. The layered component of claim 128, wherein the at least one salt comprises an ammonium fluoride salt, an ammonium hydroxide salt or a combination thereof.

130. The layered component of claim 117, wherein the capping moiety comprises a photoinitiator, a free radical initiator or a combination thereof.

131. The layered component of claim 117, wherein the capping moiety comprises a basic species.

132. The layered component of claim 131, wherein the basic species comprises a metal hydride, a metal hydroxide or a combination thereof.

133. The layered component of claim 117, wherein the capping moiety comprises a crosslinkable functionality or at least one long chain units capped with a crosslinkable functionality.

134. The layered component of claim 116, wherein the rigid core comprises a silsesquioxane, a siloxane polymer, a multicyclic siloxane, a multicyclic inorganic compound or a combination thereof.

135. The layered component of claim 116, wherein the rigid core comprises an aromatic compound.

136. The layered component of claim 135, wherein the aromatic compound comprises a porphyrin, an annulene, a fullerene, a metallocene or a combination thereof.

137. The layered component of claim 116, wherein the rigid core comprises at least one multicyclic aliphatic bond.

138. The layered component of claim 116, wherein the rigid core comprises a bridged multicyclic compound.

139. The layered component of claim 137, wherein the multicyclic aliphatic bond comprises a cubenes or a paracyclophane.

140. The layered component of claim 117, wherein the density of the carbon-including material is >1.5 g/cc at the interface.

141. The layered component of claim 117, wherein the diffusion blocking material comprises at least one flat aromatic molecule oriented flat to the substrate.

142. The layered component of claim 117, wherein the dense carbon-including material comprises at least one of graphite, diamond, a porphyrin layer, cyanine layer, a polyporphryin layer, a conductive polymer or a combination thereof.

143. The layered material of claim 105, wherein the diffusion blocking material comprises at least one metal-ligand compound or a CVD or ALD precursor material.
